(19) United States
(12) Patent Application Publication
(10) Pub. No.: US 2007/0053431 A1
(43) Pub. Date: Mar. 8, 2007

(54) Methods and devices for encoding and decoding a sequence of images by means of motion/texture decomposition and wavelet encoding

(75) Inventors: Nathalie Cammas, Rennes (FR); Stephane Pateux, Saint Gregoire (FR); Nathalie Laurent, Vignoc (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: France Telecom, Paris (FR)

(21) Appl. No.: 10/549,827

(22) PCT Filed: Mar. 19, 2004
(86) PCT No.: PCT/FR04/00689

§ 371 Date: Sep. 7, 2006

(30) Foreign Application Priority Data
Mar. 20, 2003 (FR) 03/03449

(51) Int. Cl. H04N 11/02; H04B 1/66; G06K 9/36; H04N 7/12; H04N 11/04; G06K 9/46

(52) U.S. Cl. 375/240.12; 375/240.19; 382/232

(57) ABSTRACT

A method of encoding a source image sequence. The method includes: motion/texture decomposition, such as to produce, for at least some of the source images, information that is representative of motion, known as motion images, and information that is representative texture, known as texture images; and wavelet encoding, said encoding being applied to difference images (residue) which are obtained by comparing a motion image, or texture image respectively, with a corresponding estimated image.

### 1. FIELD OF THE INVENTION

The field of the invention is that of the encoding and decoding of a sequence of video images, for example for its storage or transmission to at least one terminal.

Video encoding is used in many applications requiring varied and variable resources and bandwidths. To meet these different needs, it is useful to have available a video stream with properties of scalability, i.e. capable of adapting to the available resources and bit rates.

The invention falls especially within this framework.

Scalability can be obtained especially through the use of wavelet transforms in a video-encoding scheme. It is indeed observed that these two aspects, wavelets and scalability, each enable a signal to be represented hierarchically.

### 2. PRIOR ART

2.1 Video Encoding Using 3D Wavelets

Several video-encoding schemes using wavelet have already been presented in the literature. It has been proposed especially to use 3D (three-dimensional) wavelet transforms, for example in the following documents:
S.J. Choi and J.W. Woods. Motion-Compensated 3d subband coding of video. IEEE Transactions on hnage Processing, 8(2): 15-167, February 1999;
J.R Ohm. Three-dimensional subband coding with motion compensation. IEEE Transactions on Image Processing, 3(5): 559-571, September 1994;
Secker A. and D. Taubman. Motion-compensated highly-scalable video compression using 3d wavelet transform based on lifting. IEEE 2001.
D. Taubman and A. Zakhor. Multirate 3d subband coding of video. IEEE transactions on Image processing, 3(5) 572-588, September 1994.

One of the first schemes, proposed by Taubman and Zakhor in 1994, performs a 3D wavelet transform on a sequence of images rectified with respect to the first image of a sequence. In this technique, the motion considered is only a total motion in the scene, offering only insufficient quality. The use of more complex motions, that might present zones of contraction and expansion, would necessitate the rectifying of the images on non-uniform sampling grids, and the scheme would then no longer be reversible.

Other schemes, developed especially by Ohm in 1994 and Choi and Woods in 1999, use blocks for motion representation. The 3D wavelet transform is then performed on these blocks, along the path of the motion.

However, the blockwise motion is not continuous and causes the appearance of isolated pixels or pixels that are doubly connected to other pixels. This results in temporal subbands containing many high frequencies. Furthermore, these particular pixels limit the length of the wavelet filter.

Another approach, presented especially by Taubman and Secker in 2001, uses 3D wavelets in applying the “lifting” form of the temporal transform. In this method, the temporal transform is performed at the same time as the motion compensation. The use of lifting gives a reversible transform. However, it necessitates knowledge of the direct and inverse motion fields. Now, these motion fields are costly to encode.

The use of blockwise motion fields implies the use of short filters such as the truncated 5/3 filter. This blockwise motion encoding, which is discontinuous, therefore introduces high frequencies that are difficult to encode in the subbands.

2.2 Drawbacks of These Prior Art Techniques

These different well-known approaches therefore try to use wavelets along the temporal axis. However, most of these studies use a blockwise motion, generating discontinuities during motion compensation. Because of these discontinuities, the temporal wavelets do not decorrelate the signal with the utmost efficiency. More specifically, the discontinuities create high frequencies in the subbands, which are difficult to encode subsequently by 2D wavelet.

2.3 Approach of Analysis-Synthesis Taking Account of Meshing

In an article entitled “Codage video scalable par maillage and ondelettes 3D” (Scalable video encoding by meshing and 3D wavelets) Nathalie Camas and Stephane Pateux, Conference Coresa'03 —Compression and Representation des Signaux Audiovisuels—Lyon, 16-17 January 2003, the authors presented an improvement of these techniques, based especially on an analysis-synthesis type approach and a precise representation of motion, based on meshing.

Using such motion estimation by meshing gives efficient tracking of the deformations of texture along the temporal axis. Motion compensation by meshing indeed provides for temporal continuity of the texture, which does not exist with the other methods of compensation, such as, for example, the blockwise method. This continuity can then be exploited by the use of wavelets along the temporal axis.

The present invention relates more specifically to this latter encoding technique, which it seeks to improve, especially by reducing the quantity of data to be transmitted, or to be stored, in order to represent a sequence of video images.

3. The Goals of the Invention

It is a goal of the invention especially to mitigate the different drawbacks of the prior art techniques.

In particular, it is a goal of the invention to provide an encoding technique used to transmit (or store) more information for a given bit rate, or to require a lower bit rate for given quantity of information as compared with the above-mentioned techniques.

It is another goal of the invention to propose a scalable video encoding enabling a gradual reconstruction of each image or image sequence.

It is another goal of the invention to provide an encoding technique of this kind with high qualities of robustness.

Thus, it is a particular goal of the invention to provide a compression rate that is lower than or similar to that of H264 encoding, in furthermore offering scalability and robustness.

4. Main Characteristics of the Invention These goals, as well as others that shall appear here below, are achieved by means of a method for the encoding of a sequence of source images, implementing a motion/texture decomposition, producing, for at least certain of the source images, information representing motion, called motion images, and information representing texture, called texture images, and wavelet encoding, characterized in that the method comprises the following steps:
estimating the motion, for example using at least one reference grid, so as to obtain said motion images;
projecting each of said source images on at least one reference grid so as to obtain said texture images, on which the effect of the motion has been cancelled;
comparing a motion image and a corresponding estimated image so as to obtain a motion difference image, called a motion residue;
comparing a texture image and a corresponding estimated image so as to obtain a texture difference image;
independent wavelet encoding of said motion residue and said texture residue.

Thus, the number of information elements to be encoded is sharply reduced, and hence an increase in the useful bit rate is obtained or, at constant bit rate, an improvement of the encoded and/or stored images is obtained.

The approach of the invention enables the independent processing of the motion and texture signals, since the effect of the motion has been eliminated in the texture information. These signals enable to encode both types of information independently.

Advantageously, said comparison implements a difference with an interpolated image using at least the first and/or the last image of said sequence.

Advantageously, a temporal encoding of said texture is performed, this encoding being rectified by said motion preliminarily encoded along the temporal axis, by means of a wavelet encoding.

Preferably, the method of the invention comprises an encoding of the texture comprising temporal wavelet encoding followed by spatial wavelet encoding.

According to an advantageous aspect of the invention, the method implements a motion encoding that takes account of a meshing, and preferably a hierarchical meshing.

Advantageously, the encoding of the motion also comprises a temporal wavelet encoding followed by a spatial wavelet encoding.

According to a preferred aspect of the invention, said source images are grouped together in image blocks comprising a variable number (N) of source images.

This number may vary especially as a function of the characteristics of the images. It may for example be in the range of eight images.

Advantageously, two successive image blocks comprise at least one common image. In other words, the blocks overlap.

In this case, it is advantageously seen to it that the first image of an image block is not encoded, this image being identical to the last image of the preceding image block.

This further increases the useful bit rate.

According to a first embodiment, in each of said image blocks, the motion of all the images of an image block is estimated from the first image of said block.

It is possible especially to implement a step of motion compensation relative to at least one reference grid.

Advantageously, said compensation step uses two reference grids respectively presenting the first and last images of the block considered.

Thus, according to a second embodiment, for a block of N images, the images from 1 to (N+1)/2 are piled on the reference grid representing the first image and the images from (N+1)/2 +1 to N are piled on the reference grid representing the last image.

According to another preferred aspect of the invention, the encoding method comprises a motion encoding that implements a multiple-resolution motion estimation, according to which the motion is estimated on at least two levels of image resolution.

Thus, the motion estimation may advantageously be performed on at least two levels of said hierarchical meshing.

Naturally, the invention can also be implemented for only one meshing resolution level, for example for a meshing at an irregular level adapted to the content.

Advantageously, a step is planned for projecting an image on at least one reference grid, corresponding to a sampling grid defined by the position of the nodes of a meshing in an image, so as to obtain a texture mask.

Preferably, a multiple-grid approach is implemented, characterized in that a specific reference grid is respectively associated with at least two hierarchical levels of a hierarchical meshing.

In this case, advantageously, the invention implements a weighting of the meshing nodes between said hierarchical levels with weights, representing geometrical deformation.

Preferably, said weighting is modified during the repercussion of the shift from one level to another (so as to preserve the structure of the lower meshing).

Advantageously, between two successive hierarchical levels corresponding to a coarse meshing and a fine meshing, the nodes of said fine meshing are represented by their barycentrical coordinates relative to the triangle of the coarse meshing to which they belong, said fine meshing comprising on the one hand first nodes, called direct offspring nodes, depending on the nodes of said coarse meshing and second nodes corresponding to a mid-ridge position of said coarse meshing.

Said direct offspring nodes may then take the value of corresponding parent nodes of said coarse meshing, and said second nodes may correspond to a linear combination between the four nodes of the two triangles to which said ridge belongs.

Thus, advantageously, if said node is on said ridge, then only the two far-end nodes of said ridge are taken into account, and if said node is not on said ridge, only the three nodes belonging to the triangle of said coarse meshing to which said node of said fine meshing belongs are taken into account.

According to another advantageous aspect, said multiple-grid may be adapted to motion meshing, on the basis of a initialization that relies on a geometrical approach.

In this case, the method advantageously comprises a step for the detection of at least one image support zone that has remained undefined after said projection of an image, owing to the use of a reference grid corresponding to another image, and a step for padding said undefined image support zone or zones.

Said padding step may rely especially on an analysis-synthesis type of approach, the image to be complemented being analyzed and then synthesized to obtain a residue by comparison.

Preferably, said analysis-synthesis is reiterated at least once on the residue obtained at the preceding iteration.

The padding advantageously includes a spatial padding step for at least one image followed by temporal padding step, by prediction.

Said padding step may be carried out especially by an interpolation.

Preferably, an antisymmetry is applied to the wavelet coefficients corresponding to an edge of the image so as to simulate a signal with support of infinite length.

According to another advantageous aspect of the invention, the encoded data are distributed into at least two layers, a bottom layer comprising data for the reconstruction of an image of coarse quality and top layer for refining the quality of said coarse image.

Said bottom layer may thus comprise a low-level motion stream, comprising motion data of the last image of said image block, and a low-level texture stream, comprising texture data of the first and last images of said image block.

Said top layer for its part advantageously comprises a top-level motion stream and a high-level texture stream, corresponding to the encoding of said residues.

According to a particular mode of implementation of the invention, the encoding method therefore comprises the following steps:
selecting a group of source images;
analyzing the motion in said group of source images, producing said motion images;
analyzing the texture of the source images of said group, said texture being piled on the corresponding motion images, producing said texture images;
predicting at least some of the texture images of said group of source images, producing said predicted texture images;
determining texture residues, corresponding to the difference between a texture image and a predicted texture image;
predicting at least certain of the motion images of said group of motion images, producing said predicted motion images;
determining motion residues, corresponding to the difference between a motion image and a predicted motion image;
applying a wavelet encoding to said texture residues and to said motion residues.

The invention also relates to the signals generated by an encoding method as described here above.

A signal of this kind representing a sequence of source images and obtained by implementing a motion/texture decomposition, producing, for at least some of said source images, information representing motion, called motion images, and information representing texture, called texture images, and a wavelet encoding. It comprises digital data representing wavelet encoding applied to difference images, called residues, obtained by comparison between the source image and a corresponding estimated image.

Preferably, it is constituted by at least two layers, one bottom layer comprising data for reconstructing a coarse quality image and one top layer enabling the quality of said coarse image to be refined.

Advantageously, said bottom layer comprises successively a base stream, comprising resetting data, a first stream representing motion and a first stream representing texture, and said top layer comprises successively a second stream representing motion and a second stream representing texture, said second streams corresponding to the encoding of said residues.

According to another aspect, the signal has three fields to describe an object, respectively representing its motion, its texture and its shape.

The invention furthermore relates to methods for decoding such a signal and/or corresponding to the encoding method.

Such a decoding method advantageously comprises the following steps:
decoding the motion, in taking account of at least certain of said residues pertaining to the motion, to form motion images;
decoding the texture, in taking account of at least certain of said residues pertaining to texture, to form texture images;
synthesizing a sequence of decoded images, corresponding to said sequence of source images, by projection of said texture images on said motion images.

Preferably, it comprises a step for measuring the quality of said sequence of decoded images, by analysis of the distortion between the original texture images and decoded texture images.

Advantageously, said motion-decoding step comprises the following steps:
generating a hierarchical meshing on the first image;
decoding motion information associated with the last image, to determine a meshing associated with the last image;
interpolation of the intermediate motion images.

Preferably, it then comprises a step for decoding said residues, comprising a wavelet transformation which is the inverse of that applied when encoding, and a step for adding said residues to said interpolated intermediate motion images.

Similarly, said texture-decoding step advantageously comprises the following steps:
generating a texture for the first image;
decoding texture information associated with the last image, to determine a texture associated with said last image;
interpolating intermediate texture images.

According to a particular aspect, for at least some of said image blocks, called “inter” blocks, the step for generating a texture for the first image takes account of the last image of the preceding image block.

Advantageously, the decoding method then comprises a step for decoding said residues, comprising a wavelet transformation which is the inverse of that applied when encoding, and a step for adding said residues to said interpolated intermediate texture images.

It may furthermore advantageously comprise a step for the management of the reversals generated by said motion estimation.

Preferably, it comprises a step for stopping the processing of said residues, when a level of quality and/or a quantity of processing operations to be performed is attained.

The invention also relates to encoding and/or decoding devices implementing the above-described methods, data servers, storing and capable of transmitting signals according to the invention to at least one terminal, digital data carriers capable of being read by a terminal and bearing such signals, as well as computer programs comprising instructions to implement an encoding and/or a decoding operation according to the invention.

### 5. LIST OF FIGURES

Other features and advantages of the invention shall appear more clearly from the following description of a preferred embodiment, given by way of a simple, illustrative and non-restrictive example, and from the appended drawings, of which:

FIG. 1 is a simplified flowchart illustrating the general principle of the encoding according to the invention;

FIG. 2 is a more detailed flowchart of the encoding scheme of FIG. 1;

FIG. 3 shows an example of hierarchical meshing;

FIG. 4 illustrates the principle of multiple-resolution and hierarchical estimation according to the invention;

FIG. 5 shows the progression in the levels of hierarchy and resolution;

FIG. 6 is a flow chart presenting the principle of wavelet “padding”;

FIGS. 7A to 7F illustrate the principle of the projection of an image k on an image I;

FIG. 8 represents the principle of bilinear interpolation;

FIG. 9 illustrates projection on reference grids;

FIG. 10 illustrates 2D padding by computations of low frequencies;

FIG. 11 presents an example of a texture (or motion) residue signal;

FIG. 12 is an algorithm showing the encoding of texture;

FIG. 13 is an algorithm showing the encoding of motion;

FIG. 14 illustrates the application of non-consistent vectors to a meshing;

FIG. 15 shows an example of the merging of vertices;

FIG. 16 illustrates an example of “n-manifold” meshing;

FIG. 17 illustrates an example of meshing with appropriate support;

FIG. 18 presents the extension operator used according to the invention;

FIGS. 19A and 19B respectively show a coarse grid and a fine grid that can be used in a simplified version of the invention;

FIG. 20 illustrates the principle of the geometrical multiple grid;

FIG. 21 presents a lifting step according to the invention;

FIG. 22 illustrates the principle of analysis-synthesis of a signal according to the invention;

FIG. 23 presents another analysis-synthesis scheme with polyphase matrices;

FIGS. 24 to 27, commented upon in appendix 4, relates to certain aspects of multiple-grid estimation;

FIG. 28 is a block diagram of the principle of tracking a meshing in the course of time;

FIG. 29 illustrates the construction of a video mosaic in the course of time;

FIG. 30 presents the analysis-synthesis encoding scheme;

FIG. 31 illustrates the structure of the video stream generated according to the invention.

### 6. PREFERRED EMBODIMENTS

### 6.1 General Principle of the Invention

The encoding technique according to the invention provides for video sequence encoding by meshing and 3D wavelets.

This sequence is first of all subdivided into a group of N images, hereinafter called GOP (“group of pictures”). The number of pictures or images per GOP may vary, depending especially on the intensity of the motion in the sequence. On average, in the example described here below, the size of a GOP is eight pictures or images.

The encoding relies on an analysis-synthesis type approach. The first phase is that of the motion estimation by GOP, using deformable meshings. The second phase is that the encoding of the motion and texture of the GOP.

The motion is estimated in the images 1 and t of the GOP, where t is one image of the GOP and 1 is the first image of the GOP. The use of 3D wavelets and the analysis-synthesis nature of the encoding scheme offers natural scalability.

The meshing-based approach averts the block effects usual in prior art techniques through the use of continuous motion fields, and thus improves temporal prediction.

The encoding of the invention therefore offers a scalable and gradual stream. According to the analysis-synthesis approach, the analysis consists of the processing of a group of images belonging to a temporal window in which the motion is estimated. The compensation model obtained is used to compensate for the images from the first image of the window to the last image. The images can then be placed on reference grids, in order to separate motion information and texture information.

These pieces of information can then be encoded separately in two layers:
a base layer that can be used to represent the sampled video signal, and contains the information on the far-end temporal window images;
the images internal to the window being then capable of being interpolated between these two far-end images;
at least one subsequent raising layer being capable of being added to the base layer in order to improve the quality of the reconstructed video sequence. The raising layers bring a refinement of texture and/or motion to the far-end internal images of the window.

The video sequence is reconstructed by a synthesis phase, which reprojects the texture images on their original sampling grid. The separation of motion and texture in the encoding strategy enables the lossy encoding of the motion, where the gain in bit rate can then be carried over to the encoding of the structure. The use of wavelets in the encoding of the top layer furthermore makes it possible to offer a scalable stream.

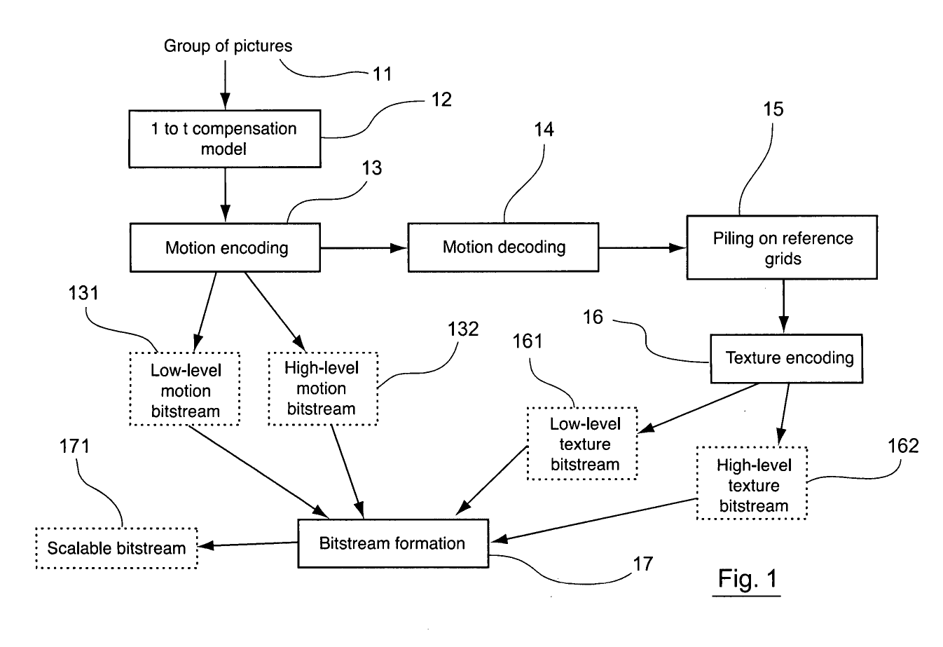

### 6.2 General Scheme of the Encoding (FIG. 1)

FIG. 1

FIG. 1 gives a general view of the principle of an encoding method, and of an encoder according to the invention.

As specified here above, each group of images or pictures 11 first of all undergoes a motion estimation step 12, based on a 1-to-t compensation model, then a motion encoding step 13 delivering firstly a low-level “bitstream” 131 and high-level or heightening “bitstream” 132.

According to the principle of analysis-synthesis, the data representing motion are re-decoded during the encoding, in a motion-decoding step 14. The step 15 for piling texture on the reference grids delivers pieces of information on this texture, which are then encoded (16), in two streams 161 and 162, respectively corresponding to a low-level texture “bitstream” and a high-level texture “bitstream”.

The different streams 131, 132, 161, 162, which are then organized to form a bitstream, deliver a stream designed for transmission and/or storage.

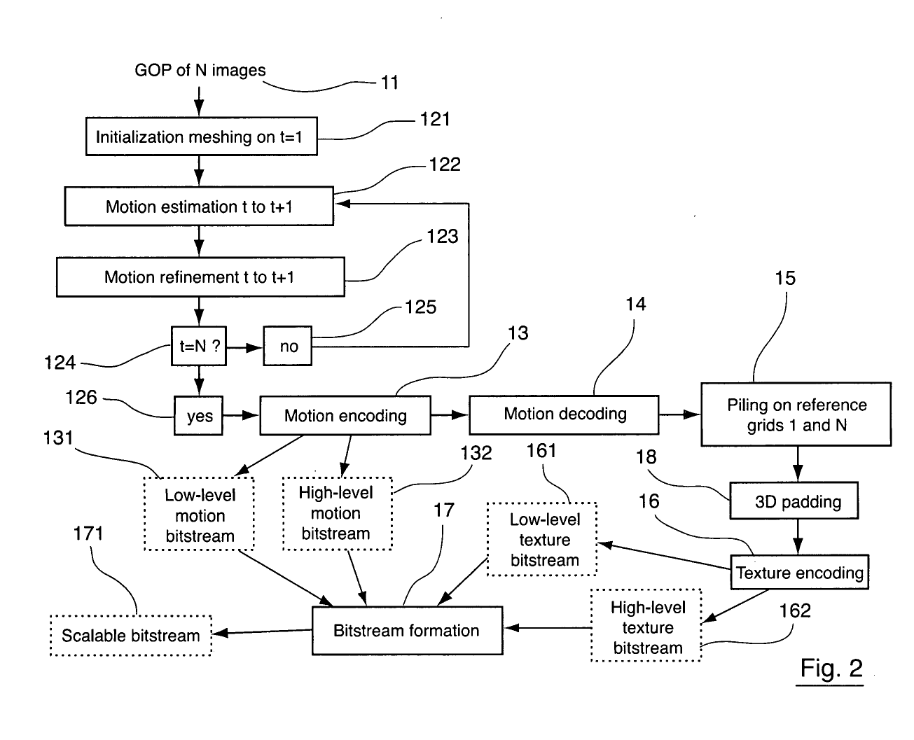

FIG. 2 is a more detailed version of the scheme of FIG. 1, in which the step 12 of compensation and the step 16 of encoding the texture are described in greater detail. It is commented upon in greater detail here below.

Principle of the Encoding

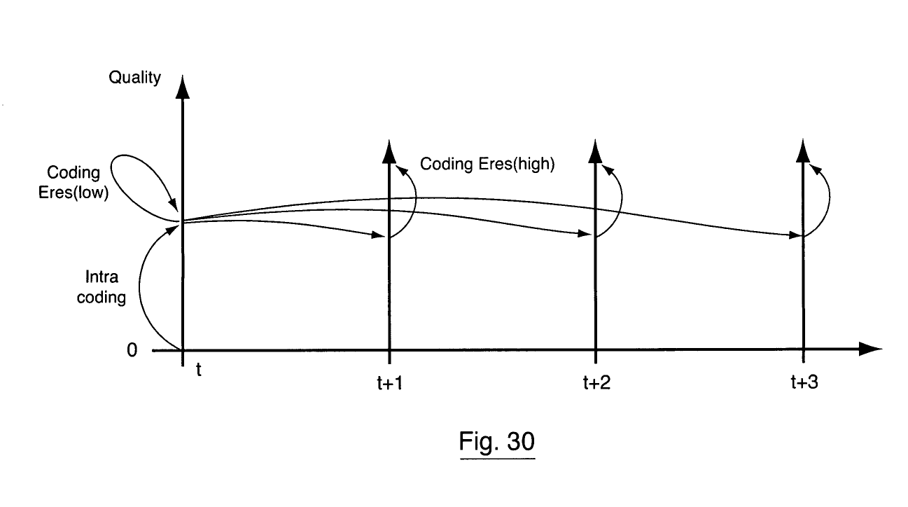

The encoding scheme proposed is an analysis-synthesis type of scheme. Each image is rendered by means of a texture piled on by means of the meshing (similarly to what can be done in image synthesis). The texture information as well as the information on the progress of the meshing are obtained by means of the motion-estimation algorithm defined here above as well as the technique for the construction of mosaic images, as illustrated in FIG. 30.

Each image is restituted by means of a dynamic texture (i.e. the previously created dynamic mosaic) piled on by means of the deformable meshing. The dynamic texture is encoded by means of a 3D wavelet representation. The information on deformation of the meshing is also encoded by a 3D wavelet. A refinement level can also be added in order to refine each image separately.

This encoding scheme offers many interesting features. First of all, it exploits the space/time correlations present in the video (especially at the level of the temporal correlation) to the maximum.

It furthermore offers the possibility of uncoupling motion information from texture information at the decoder. Thus, a lossy encoding of information on deformation of the meshing may be achieved without in any way contributing visual deterioration. For example, it is thus possible to tolerate errors of position of a pixel in the image without in any way thereby causing visual discomfort. In a classic closed-loop encoding scheme, it would then be necessary to correct this motion error through the encoding of the texture.

The potential gain in the encoding of motion information is particularly important because, during the application at low bit rate (for example 256 kbit/s for CIF at 30 Hz, the motion information may take up 30 to 40% of the total bit rate in a H263 type scheme).

In order to encode the texture and motion information fields, a 3D wavelet encoding technique is used. This technique is based on the use of the JPEG 2000 wavelet encoder for texture which can be used to achieve a bit rate-distortion optimization of the encoding while at the same time offering maximum (spatial and SNR) scalability. Since the JPEG2000 is basically a 2D image encoder, 3D wavelet encoding is obtained by providing it with multiple-component images, the components representing the different temporal subbands of the volume of 3D information considered.

Structure of the Encoding and Scalability

In order to encode a video sequence, this sequence is first of all subdivided into GOP (Groups of Pictures). In each GOP, the information on motion and the information on texture are encoded separately, and scalably. In a manner similar to that of the MPEG encoding structure for images, two types of GOP can be distinguished: intra GOP and inter GOP. An intra GOP is a GOP that is decoded independently of the other GOP (such as for example the first GOP of the sequence). An inter GOP is a GOP encoded differentially relative to the preceding GOP (the aim of this inter encoding is to improve compression by preventing the encoding of an intra image at the beginning of the GOP).

For each of these GOPs, the meshing used in the first image is a regular meshing; it is therefore known to the encoder and decoder and does not need to be encoded (the cost of the parameters that define it such as the number of hierarchy levels or again the size of the meshes may indeed be overlooked). The first image of the GOP is either “intra” encoded (in the case of an intra GOP) or retrieved from the preceding GOP (the inter GOPs have their first image in common with the preceding GOP).

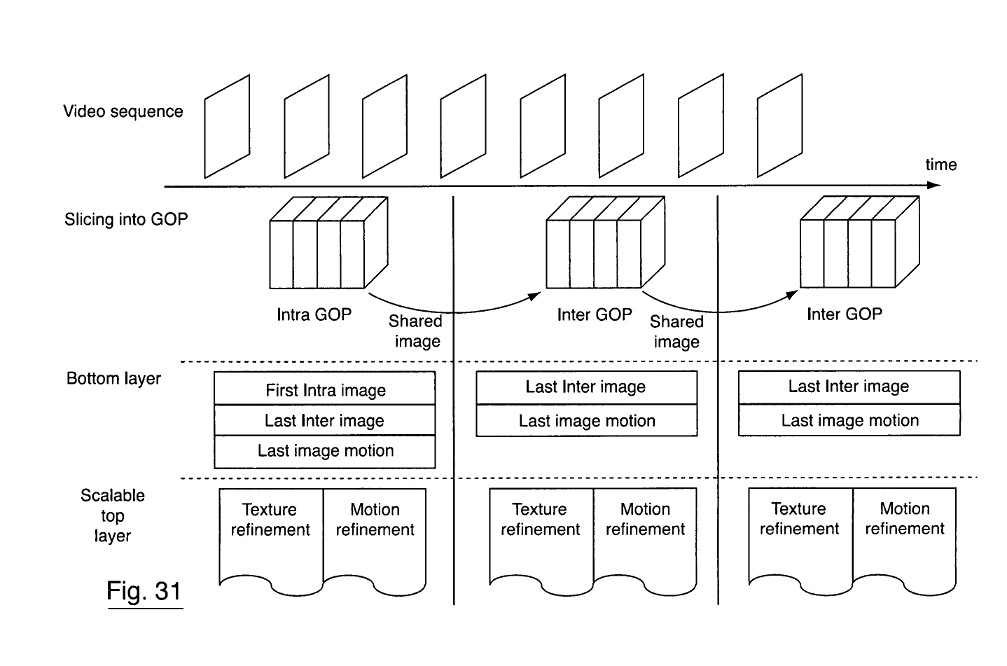

In order to propose maximum scalability, the pieces of information defining the last image are first of all encoded (deformations of the meshing, variations in texture on the mosaic between the first reconstructed image of the GOP and the last image of the GOP). Finally, the residual pieces of information are encoded by a 3D wavelet using a scalable encoding technique (cf. JPEG2000). FIG. 31 summarizes the different levels of representation.

The bottom layer may be similar to an IPPPP-type bottom layer of an MPEG scheme. The scalable top layer of the bitstream brings gradual improvement to the intermediate and end images of the GOP.

Encoding of Information on Texture

As can be seen in FIG. 31, the texture information on a GOP is encoded in two stages. In an initial stage, a bottom layer is encoded: this consists of the encoding of the first image (if it is an intra GOP), and the encoding of the texture of the last image in differential mode. In a second stage, the residue for its part is encoded via a 3D wavelet.

The residual information to be encoded is defined for each image of the GOP, ranging from the instant t₀ to the instant t₁, as being the image:

$${R}_{t} = {I}_{t} - [ \frac{{t}_{1} - t}{{t}_{1} - {t}_{0}} {I}_{{t}_{0}}^{low} + \frac{t - {t}_{0}}{{t}_{1} - {t}_{0}} {I}_{{t}_{1}}^{low} ] .$$

A temporal wavelet transform is then defined on the images of residues (use of the Daubechies 9,7 type filter). The images considered for this wavelet transform are all the residue images for the GOP (except for the image of the residue of the first image for an inter GOP). The images of the different temporal subbands are subsequently encoded via the JPEG2000 encoder in defining each of the temporal subbands as being a component of the image to be encoded.

Since the motion compensation has been done beforehand, it is no longer necessary to take account of the presence of motion in the encoding.

At the decoding level, initially all the pieces of low-layer information and then the pieces of top-layer information (information depending on the type of scalability used for the encoder) are decoded. The increments coming from the top player are then added to the decoding information from the bottom layer.

Encoding of the Information on Motion

The motion information is encoded similarly to the texture information. At the low-layer level, the position of the meshing is encoded solely for the last image of the GOP. At the top layer, a residue is computed on the positions of the meshing via a linear interpolation of the position of the nodes at the ends of the GOP.

The encoding of the shift in the bottom layer is achieved through a DPCM type encoding and by the use of a uniform scalar quantification. To do this, a JPEG-LS type encoder has been adapted.

On the top layer, the temporal wavelet transform is initially made for each node by means of a Daubechies 9,7 filter. This temporal transform gives a set of clusters of values corresponding to each temporal subband. These clusters of values correspond to the values associated with the nodes of the meshing.

Similarly to what was proposed in [Marquant-2000], a meshing-based wavelet transform is performed on these values in order to obtain spatial subbands. The space-time subbands are subsequently encoded in bitmaps by means of a contextual arithmetic encoder. A bitrate-distortion optimization is achieved in order to define, for each space-time subband, the final bit map level chosen for the encoding (a technique similar to the bit rate allocation made by the JPEG2000 in which large-sized EBCOT blocks would be used).

In the first phase of the study, the scheme for encoding the motion information was based on the encoding of the meshing hierarchically and by using an adapted meshing so as to obtain a good compression rate. The use of wavelets may be seen in fact as a method that generalizes this type of encoding. Quantification reveals non-encoded zones in the hierarchical tree. The advantage of the wavelet approach is that it gives fine scalability as well as appropriate bitrate-distortion optimization, which was relatively difficult to define in the previous approach.

### 6.3 Estimation of Motion

The first step of the encoding scheme is the estimation of the motion. The following three points present different methods of estimation of the motion between two successive images. The last point presents the estimation method chosen for the present encoder.

The Motion Estimation (Reminders)

The motion is estimated between two successive images t and t+1 by means of the deformable meshings. The general principle of motion estimation consists of the minimizing of a finctional equation

$${\sum }_{p ∈ Ω} ρ ( I ( p , t ) - I ( p - dp , t - 1 ) ) ,$$

with Ω as the estimation support, ρ as the error metric, the most used is ρ(r)=r², I(p,t) the value of the image I at the point p and at the instant t, dp the dense motion field. dp can be written as:

$${\sum }_{i} {w}_{i} ( p ) {dp}_{i}$$

where wᵢ(p) represents the coordinates of p relative to the nodes i, and dₚᵢ represents the shift associated with the node i.

An algorithm for minimizing the finctional equation is described in the thesis by Marquant00<< Representation par maillage adaptatif deformable pour la manipulation et la communication d'objets videos>>—Representation by deformable adaptive meshing for the handling and communication of video objects—Gwenaelle Marquant. Thesis at the Universite de Rennes 1 presented on 14 Dec. 2000). The minimization is performed on the nodes of the meshing, i.e. a search is made for the shift vectors dₚᵢ of the nodes from t to t+1.

The energy is minimized by a gradient descent (of the Gauss-Seidel type) iteratively. The system to be resolved has the form:

$${\sum }_{p ∈ I} \{ Ψ ( dfd ( p ) ) {w}_{i} ( p ) ∇ {I}_{x} ( p - dp , t - 1 ) [ {\sum }_{j} {w}_{j} ( p ) \cdot [ ∇ I ( p - dp , t - 1 ) Δ {dp}_{i} ] ] \} = {\sum }_{p ∈ I} [ Ψ ( dfd ( p ) ) {w}_{i} ( p ) ∇ {I}_{x} ( p - dp , t - 1 ) \cdot dfd ( p ) \}$$

$${\sum }_{p ∈ I} \{ Ψ ( dfd ( p ) ) {w}_{i} ( p ) ∇ {I}_{y} ( p - dp , t - 1 ) [ {\sum }_{j} {w}_{j} ( p ) \cdot [ ∇ I ( p - dp , t - 1 ) Δ {dp}_{i} ] ] \} = {\sum }_{p ∈ I} [ Ψ ( dfd ( p ) ) {w}_{i} ( p ) ∇ {I}_{y} ( p - dp , t - 1 ) \cdot dfd ( p ) \}$$

$$∀ i , dfd ( p ) = I ( p , t ) - I ( p - dp , t - 1 ) , Ψ ( r ) = \frac{{ρ}^{′} ( r )}{r}$$

The unknown factors of this system are the Δdpᵢ values. This system is a linear system of the A.X=B type and it is hollow. The solution may be obtained by a robust, fast, conjugate gradient technique.

Multiple-Resolution and Hierarchical Estimation

In the case of the encoder of the invention, the estimation of the motion can also be done by multiple-resolution and hierarchical meshing. This technique is aimed at providing for improved convergence of the system. Indeed, during heavy motion, it may happen that the prior minimization technique does not 20 converge, and furthermore the use of many fine meshings could prompt an instability of the system due to an excessively large number of parameters in the system.

The motion estimation technique using hierarchical meshing consists in generating a hierarchical meshing on the images t and t+1 and in estimating the motion on different meshing levels.

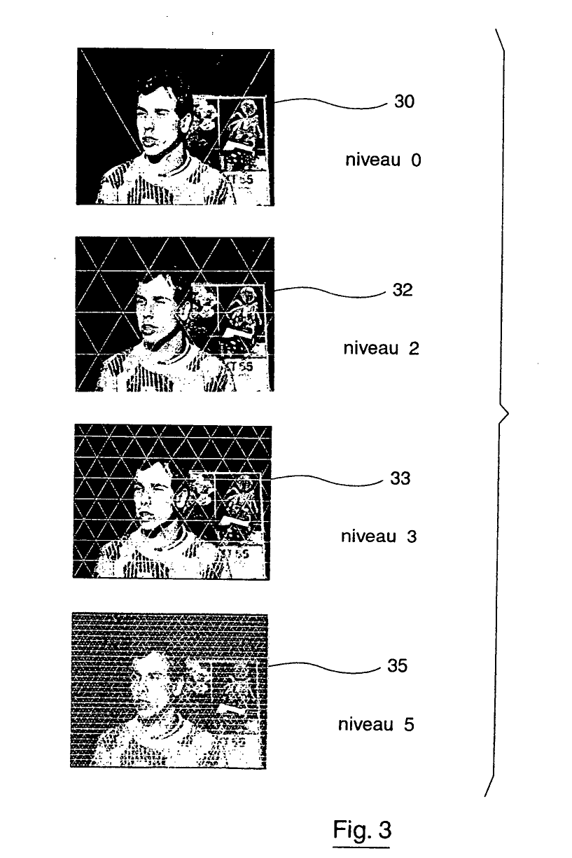

FIG. 3 shows an example of hierarchical meshing. The hierarchical representation is constituted by several levels of representation: the lowest level 30 (level 0 in the figure) has a coarse field (only three nodes to define the meshing).

In going toward the finer levels 32, 33, 35, the field gradually densifies and the number of nodes of the meshing increases. The quality of the motion varies with the levels, the low level 30 representing the dominant motion of the scene, and the fine levels refining the dominant motion and represent the local motions. The number of levels of the hierarchical meshing is an adjustable parameter of the estimation phase: it may vary according to the sequence to be estimated.

The multiple-resolution estimation technique consists in estimating the motion at different levels of resolution of the images. The motion is first of all estimated between the images at the lowest resolution, and then it is refined in using increasingly finer images. As already mentioned, the invention can be applied also in the case of a meshing with only one level, for example a meshing that is uneven and adapted to the content.

The use of low resolution values limits the amplitude of the motion; thus, a wide-amplitude motion with fine resolution of the image will have a low amplitude at coarse resolution. A pyramid of filtered and decimated images is built from the images t and t+1, and then the motion is estimated from the coarse level toward the finer levels.

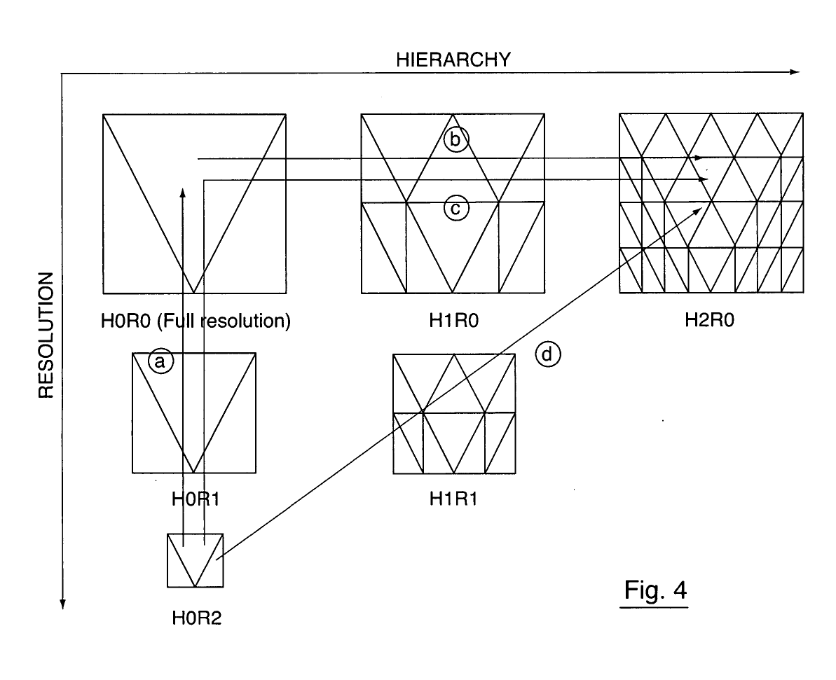

The estimation of the multiple-resolution and hierarchical motion, an example of which is presented in FIG. 4, couples the preceding two techniques. Initially, the estimation is made on a course meshing and a coarse resolution level. Then, the resolution and hierarchical levels of the meshing are refined in order to tend toward the functional value corresponding to the full-resolution image with a fine meshing.

FIG. 4 shows the different possibilities of refining the meshing and the resolution.

The approach -a- corresponds to the multiple-resolution approach alone, and the approach -b- corresponds to the hierarchical estimation alone. The approach -c- enables the estimation, through the multiple resolution, of wide-amplitude movements on the coarse level and enables this motion to the refined locally by means of the meshing hierarchy. The approach d is another approach combining multiple resolution and hierarchical meshing, and its advantage is that it uses adequate levels of resolution relative to the size of the triangles of the meshing. The principle of this hierarchical multiple-resolution approach for motion estimation has been developed in the already-mentioned thesis by Marquant00.

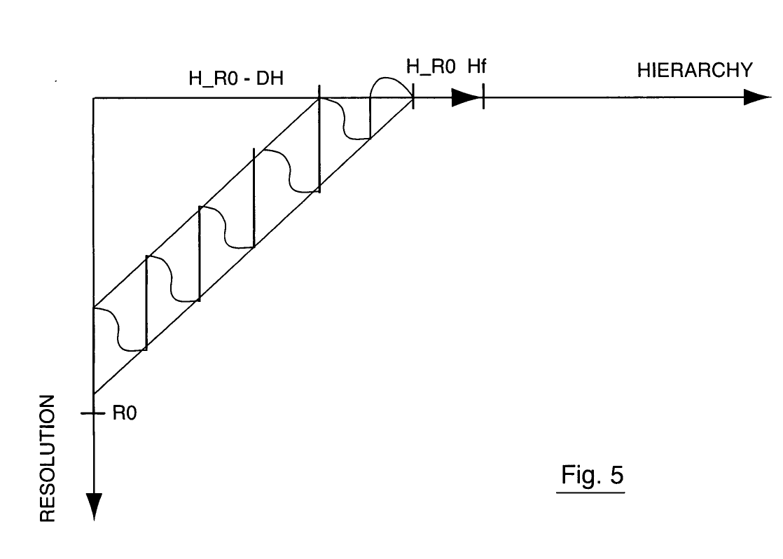

FIG. 5 shows the approach chosen for motion estimation, according to a preferred embodiment of the invention. This technique makes it possible to take account of the different types of motion that may be encountered. The parameter RO is the coarsest level of resolution used, H_RO controls the amplitude of the estimated local motions, DH limits the bias related to estimation on a low-resolution image and Hf represents the finest hierarchical level.

These parameters depend on the type of sequence. One set of fixed parameters giving good results is the following: Hf is defined in order to have the desired meshing fineness for the motion estimation, H_RO=Hf, DH=2, RO =3.

Multiple-Grid Estimation

The principle of this technique is made explicit further below. This technique is related to the multiple-resolution and hierarchical meshing approach during the motion estimation. Multiple-grid estimation is used to resolve the problems of sub-optimality that appear during motion estimation on non-even meshings.

Combination

The motion estimation used in the encoder is an approach combining multiple-resolution, meshing hierarchy and the multiple grid explained further above. As illustrated in FIG. 2, the motion is estimated (122) between successive images t and t+1, then refined (123) by estimation between 1 and t+1, where 1 is the first image of the GOP. The meshing is reset (121) at the first image of the following GOP. This approach is repeated (124, 125, 126) for the N images of the GOP.

Motion Padding

Padding corresponds to the extrapolation of motion outside the zone defined by the object. The aim of padding is thus to complete an incomplete signal by values close to the original signal. This operation appears to be necessary once there is an incomplete signal and once it has to be processed as a complete signal.

In motion estimation, this operation takes place at the end of the estimation of motion between all the images. Indeed, within a GOP, the estimation is relaunched each time from the deformed meshing derived from the previous estimation, and when meshes come out of the field of definition of the image, they keep their deformed shape. Now, thereafter when these meshes again enter the field of definition (to-and-fro movement in the image), the following estimation is of better quality if the meshes that come in are homogeneous, i.e. if they are no longer deformed.

A motion padding operation is then applied at each end of estimation in order to smooth the meshes located outside the field of definition of the image.

The principle of the padding may be the same whatever the type of information to be completed, whether it is texture or motion. It is similar to the multiple-grid approach seen further below. The principle is therefore that of analysis-synthesis, and a hierarchical wavelet representation of the information is used.

If s is the signal to be completed, a search is made for Ŝ as an approximation of the signal such that

$$\hat{s} = {\sum }_{k} {c}_{k} {φ}_{k} ,$$

with φₖ being a base of orthonormal functions.

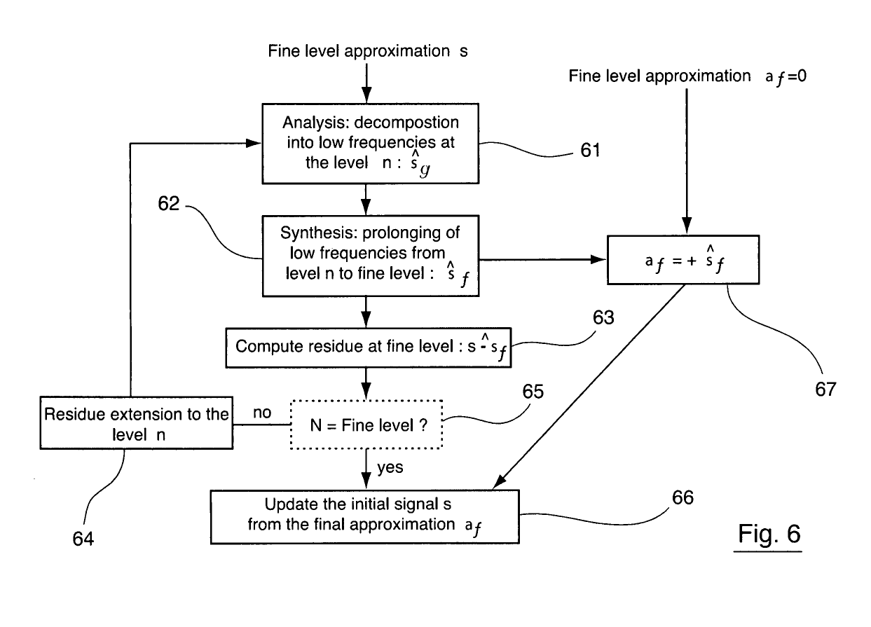

For this purpose, the functional ||s−ŝ||² is minimized. The minimization method is done iteratively, as illustrated in FIG. 6.

A first coarse approximation ŝ_{G} is computed (analysis 61), then this first approximation is extended to the fine domain (synthesis 62), to obtain (67)ŝ_{f}. A computation is made (63) of the residue s−ŝ_{f}, and the first approximation is then refined by applying the process to the computed residue.

The process is reiterated up to a stop criterion (65), which tests whether the residue is below a certain threshold, determining the fineness of the approximation of the signal. Padding then consists in filling the zones of the incomplete initial signal by the complete approximation of the signal (66).

The steps of analysis and synthesis depend on the nature of the signal to be completed, depending on whether the signal represents information on motion or on texture. If the signal represents information on motion, the signal to be completed is a hierarchical meshing. It is sought to complete the fine hierarchical level, and the approximations will then be computed successively on the lower levels, in going from the coarsest level to the finest level.

The analysis on a level is done by the resolution of the system enabling the wavelet motion to be determined at this level, i.e. a search is made for the best motion from the meshes of this level.

The approximation of the fine level is then updated with the solution found. The residue of the system is computed on the fine level, and the operation passes to the higher coarse level, the system of the fine level being converted to the coarse level, and a search is made for the wavelet motion of this level. As and when the propagation occurs in the levels, the approximation of the fine level gets refined. The process stops when the system has been restored for each coarse level. Finally, the values not defined in the initial fine meshing are updated from the fine approximation.

The analysis and the synthesis of a texture signal are explained further below in the part pertaining to the separation of movement and texture.

### 6.4 Scalable Encoding on Two Layers

Basic Layer

The encoding is done on two layers: a bottom layer and a top layer. The bottom layer contains information on the first and last images of the GOP. The intermediate images of the GOP are reconstructed by interpolation between these two images.

The motion and the texture are obtained by linear interpolation, and then the images are synthesized on their sampling grid on the basis of the interpolated motion and texture. Linear interpolation has the following form: I(t)=a*I(1)+(1−a)*I(N), with I(1) as the first image of the GOP, I(N) as the last image of the GOP, I(t) as an image of the GOP between 1 and N, a=t/N, Ix representing either the information on texture of the image x, or the information on motion.

The bottom layer is the basic layer which provides for minimum quality of reconstruction for the encoder. It represents the initial signal sampled by a step of N images.

Closed-Loop P Type Bottom Layer

The bottom layer is of a P type, the first image is intra encoded, the following images are encoded by prediction on the basis of the preceding image I or P encoded-decoded to work in a closed loop. The bottom layer contains the texture and motion information of the last image of the GOP and the information of the first image if the GOP is an intra GOP.

If the GOP is an intra GOP, then the bottom layer contains the encoded image I(1). The image I(N) is encoded by prediction; I(N)-Î(1) is encoded, where Î(1) is the encoded-decoded image I(1). If the GOP is not an intra GOP, then only the motion and texture information of I(N) are encoded in the bottom layer. In this case, to predict I(N), the invention uses I(N) of the previous GOP, i.e. I(1) if the current GOP is equal to I(N) of the previous GOP, with I(N) being the encoded-decoded image I(N).

Scalable Refining Layer

The top layer is a refining layer that contains information on motion and texture of the images of the GOP. The refining of the far-end images (the first and last images of the GOP) is a refinement of the encoding relative to their version in the bottom layer. The refinement of the intermediate images is the prediction error between these images and their interpolation from the bottom layer; this error is dI(t)=I(t)−I(1)−a*(I(N)−I(1)).

The top layer is encoded, for example, by a JPEG-2000 encoder, offering a scalable stream.

### 6.5 Separation of Motion and Texture

Piling of the Images on a Reference Grid

i. The motion is encoded separately from the texture. The motion is given by the position of the nodes of the meshing at each instant t, corresponding to each image. The texture is retrieved by an operation for piling images on a reference grid.

The reference grid is a sampling grid defined by the position of the nodes in this image. The operation of piling the image i on the image k consists in reconstructing the image i on the grid of the image k, i.e. in rectifying the image i relative to the image k; the reconstruction image Ir has the same sampling grid as the image k.

The reconstruction support of the images may be greater than the initial support of the image in order to take account of the motions that emerge from the image, the size of the support is determined at the estimation of the motion and depends on its amplitude. At the time of the piling on the reference grid, a mask having the same size as the piling support and indicating the pixels of the support that have been rebuilt is also retrieved.

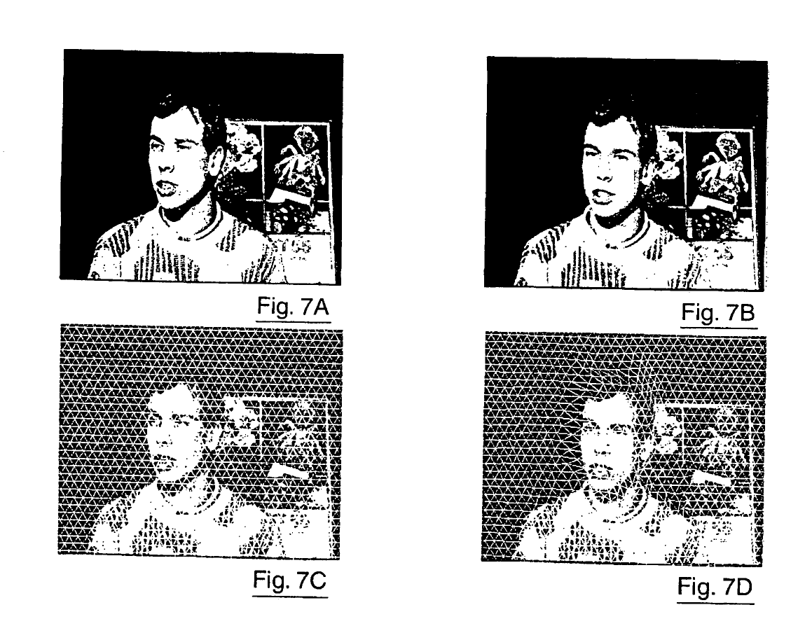

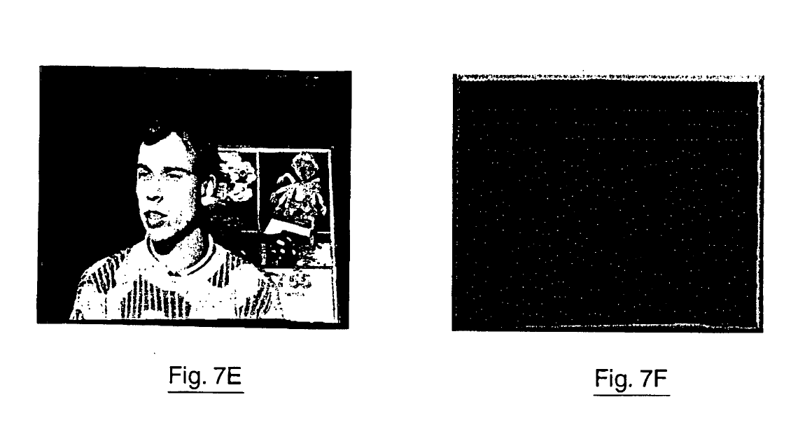

The example illustrated in FIGS. 7A to 7F shows the piling of an image k (FIG. 7B) on an image i (FIG. 7A), the motion between i and k (position of the meshing at i (FIG. 7C) and the position of the meshing at k (FIG. 7D)) being known.

The algorithm 1 presented in appendix 3 is the algorithm for reconstruction of the image k projected on the image i (FIG. 7E). To reconstruct the image Ir, this image is scanned, the positions of the pixels being therefore integers, and a search is made for the correspondent of each pixel of Ir in the image k by the application to it of the inverse motion from i to k.

As the motion vectors have no integer values, the corresponding pixel has no position with integer values. A bilinear interpolation is then necessary to compute its luminance value.

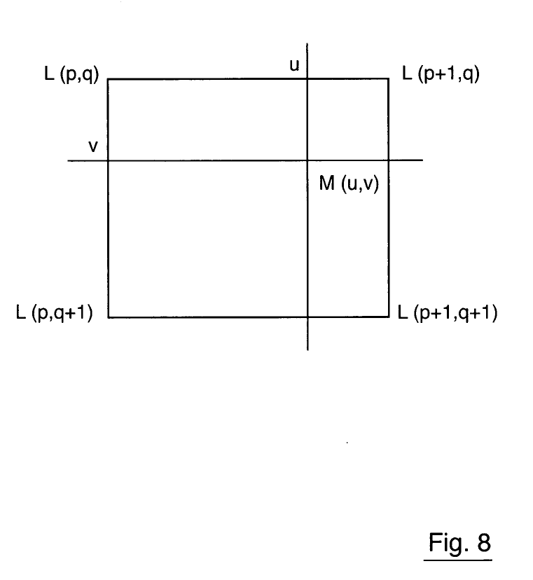

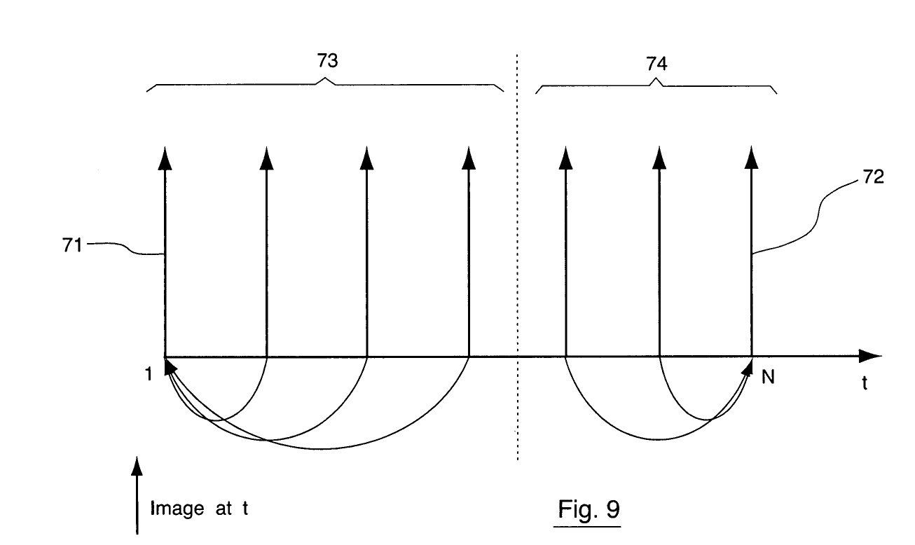

FIG. 8 provides a detailed description of the bilinear interpolation performed between the luminance values at integer values:

Bilinear Interpolation of the Luminance L in M:
a=(1-u)*L(p,q)+u*L(p+1 ,q)
b=(1−u)*L(p,q+1 )+u*L(p+1,q+1)
L_{(u,v)=(}1−v)*a+v*b

The luminance thus computed is assigned to the current pixel of the image Ir to be reconstructed. The reconstructed pixels must first of all be contained in the defining mask of the image i, then the shifted pixels must be predictable, i.e. contained in the defining mask of the image k, the prediction mask (FIG. 7F) of the image k then takes the “true” value at the pixels meeting these two criteria.

ii. In the choice of a reference grid as for the projection of the images and the retrieval of the textures, the invention, as illustrated in FIG. 9, uses two reference sampling grid, that of the first image 71 and that of the last image 72 of the GOP. For a GOP of N images, the images 73 from 1 to (N+1)/2 are placed on the first image 71 of the GOP, the images 74 from (N+1)/2+1 to N are placed on the image N 72.

3D Padding of Texture

iii. 2D Padding

The piling of the images on a reference grid other than their one implies that zones of the support remain undefined after the piling operation. These zones are identified by means of the prediction mask of the piled image. These non-defined zones are filled by a padding operation.

The padding of an image consists in filling the zones in which the image is not defined by values close to those defined in the vicinity. The padding is based on a principle of analysis-synthesis.

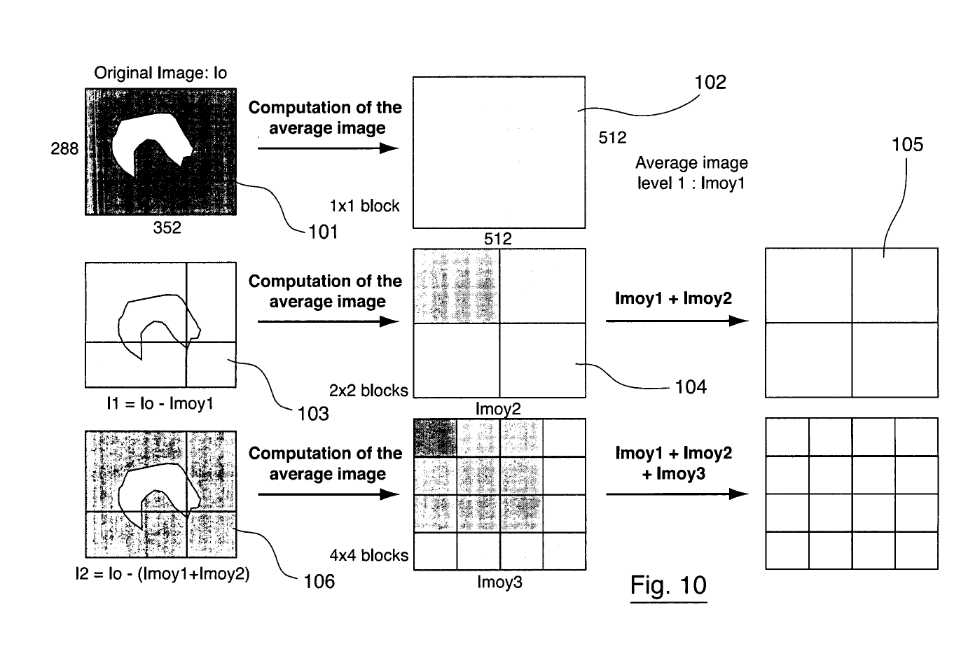

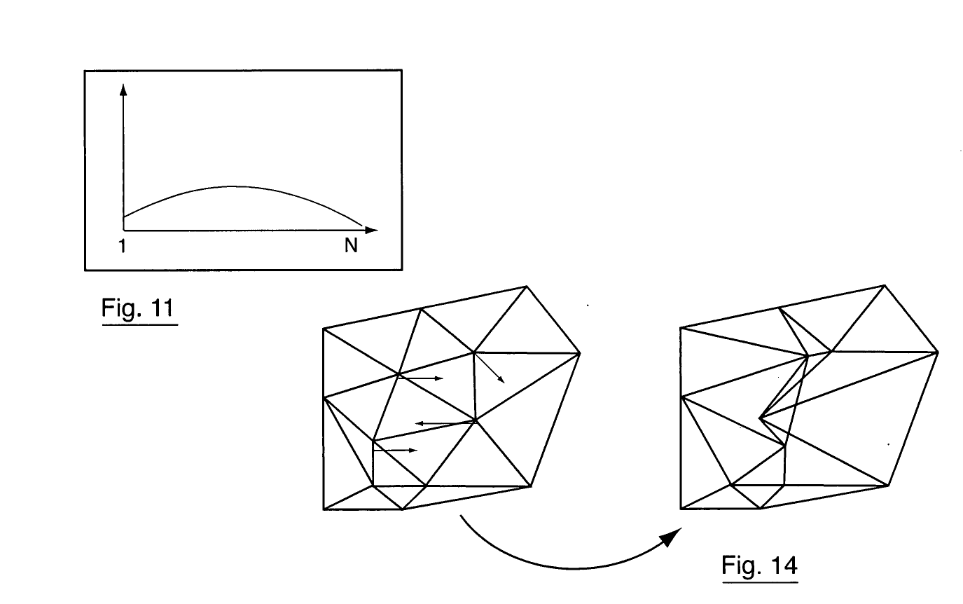

The image to be completed is analyzed, then synthesized, and the residue is computed relative to the synthesis and the analysis is resumed on this residue. FIG. 10 shows a principle of this kind. Successive low-frequency versions of the image are computed with the values defined on blocks overlapping the image, then the low-frequencies are successively expanded in the undefined zones.

For example, for an image Io 101 in the CIF format sized 352×288 pixels, a first low-frequency is computed on a block sized 512×512 overlapping the entire image. The average is computed on the pixels of the image which are defmed in the prediction mask, and the non-defined pixels are at 0 (in black in the figure).

An average image Imoyl 102 having the size of the block is filled with the value of the computed average.

Since there is only one block, there is only one average value. A residual image 11 103 is then computed by subtracting the original image from the average image (I1=Io-Imoyl).

(*) The block sized 512×512 is divided into 4, (the blocks are sized 256x 256), and the process then resumes the computation of the average on each block, but the average is now computed on the pixels of the residue image I 1 which are defined in the prediction mask of the original image. The average image Imoy 2 104 obtained is added ( 105) to the previous average image. The last image obtained 105 is subtracted from I1 to obtain I2 106.

The process resumes from (*) in considering 12 instead of II. This process is iterated until the size of the blocks is equal to the size of the pixel.

The padding of the zones not defined by the low-frequency versions causes fuzziness in the these non-defined zones relative to the defined zones.

However, the continuity in the image is preserved. The non-defined zones become defined after the padding operation, and the prediction mask of the original image then takes the “true”value in every pixel of the image.

iv. Temporal Padding

The padding done by the encoder is a 3D padding. It takes account of the 2D images and of the temporal dimension. A 2D padding is done on the first (Iᵢ) and last image (IN) of the GOP, then a temporal padding is done to complete the other images of the GOP.

The temporal padding uses the fact that the internal images of the GOP are predicted by a linear interpolation between the two far-end images. Since the prediction residues are then encoded by 3D wavelet, it is sought to have residues that are as small as possible. The padding must therefore complete the non-undefined zones with values that will give very small residues, or even zero residues, while keeping spatial and temporal continuity.

This is why the internal images of the GOP are completed by linear interpolation on the basis of the two spatially padded far-end images. Hence each image of the GOP between 1 and N is scanned, and this is done for each pixel of the current image t. If the pixel is non-defined in the mask, its value is then: a*I(1)+(1−a)*I(N), where a=t/N.

### 6.5 Motion Encoding

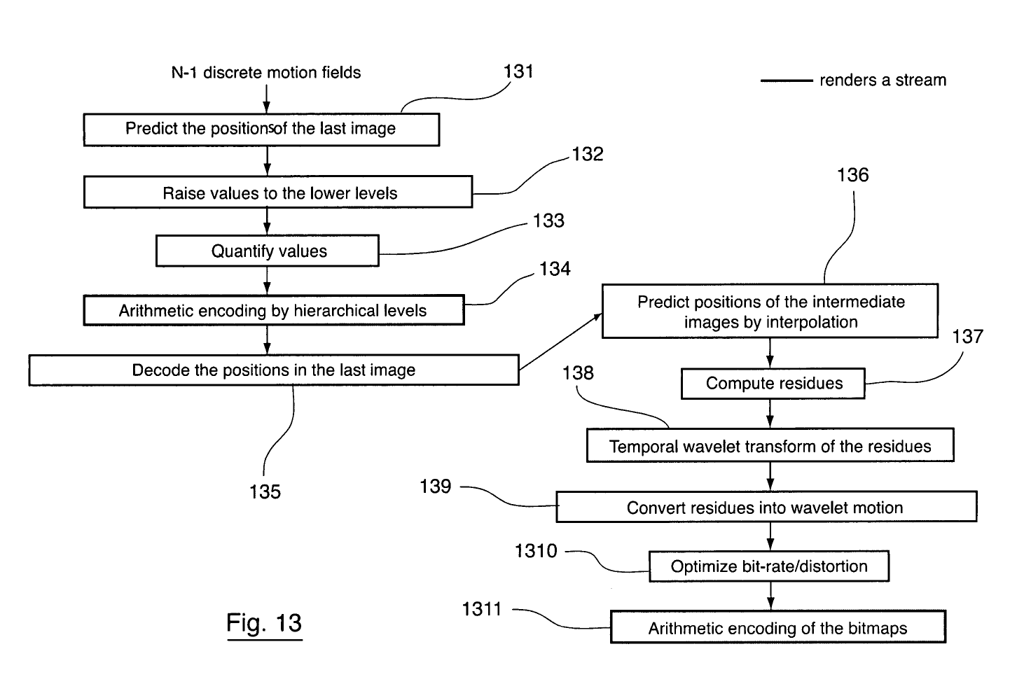

The principle of this encoding is illustrated by the flowchart of FIG. 13.

Encoding in the Bottom Layer

In the bottom layer, the pieces of motion information encoded relate to the positions of the meshing in the last image of the GOP.

i. A prediction (131) is made of the positions of the meshing in the last image with the positions of the meshing in the first image of the GOP. The prediction error is then encoded, as explained here above: (P type bottom layer).

ii. The pieces of motion information coming from the estimation are given for the finest hierarchical level of the meshing . A raising (132) of the values toward the coarsest levels is then performed. For the coarsest level, we have the positions of the nodes acting at this level, and for the following finer levels, the positions of the new nodes, the mid-arc nodes .

iii. The values are then quantified (133) with a qualification step of the 0.5.

iv. Then the quantified values are passed into an arithmetic encoder (134) which defines a different statistic for each hierarchical level. An arithmetic encoder encodes a set of values by a message consisting of several symbols. The symbols are not encoded separately. If the resulting message is represented by means of intervals, each possible message is encoded on an interval Ii of probability pi. The statistic of an arithmetic encoder is the set of the probabilities of each interval. In the case of the invention, the encoder initializes the probabilities at 1/n, where n is the number of symbols to be encoded; at the outset, the messages are each equiprobable. The probabilities are updated whenever a value of the set has to be encoded. When all the values are encoded, it is enough to transmit a number included in the interval of the resulting message.

The arithmetic encoding of the positions of the meshing uses different statistics for each hierarchical level, because the values on a given hierarchical level have greater chances of being close to each other than values between different levels. The similitude of the values enables a reduction of the size of the message to be transmitted, and a gain in encoding cost.

v. Only the valid nodes of the meshing are encoded. A node is valid if it belongs to a valid triangle, and a triangle is valid if it reconstructs at least one pixel in the mask of the image. The non-valid nodes reconstruct no pixel of the image, and it is unnecessary to encode them.

Encoding in the Top Layer

i. The pieces of motion information in the top layer are pieces of information on the intermediate positions of the meshing, between the first and last image of the GOP. Hence the positions in the last image (135) are decoded, then the positions of the intermediate images are predicted by interpolation (136). An encoding is made of the residues. The residues of interpolation between the positions in these two images and the intermediate positions are encoded (137). If m(1) and m(N) are respectively the positions of the meshing in the first and last image, the subsequently encoded residues are then: res(t)=m(t)−m(1)−(1−t)/N*m(N). The residues encoded are the residues of the valid nodes.

ii. The residues are converted (138) by a “zero side” temporal wavelet with an Antonini filter (given in appendix 1).

iii. The residue motion of the intermediate images is then converted into wavelet motion (139). The wavelet motion is the representation of the meshing by hierarchical levels where, for each level, the given position of the nodes is the optimum position for this hierarchical level. The coarsest level gives the total motion of the scene, and the finer levels enable successive refinements of the local motions. At each meshing level, the pieces of information to be encoded are the new nodes created at mid-arc positions and the refining of the positions of the nodes already present at the lower level.

iv. The fact of having optimum nodes positions for each hierarchical level enables the performance of a bit rate/distortion optimizing operation at each level.

The process of bit-rate/distortion optimization 1310 entails the computation, first of all for each hierarchical level, of the bit rates and distortions associated with the each quantification step. For a given bit rate, a search is made for the optimum combination of the different points of each hierarchical level, this combination giving the best compromise between bit rate and distortion. Each level is weighted by a weight that takes account of its influence on the quality of the motion rendered.

The coarse levels will have a greater weight than the finer levels: this means that when searching for the best combination, the distortion associated with a quantification step will be greater for each coarse level than for a fine level. Indeed, an error at a coarse level is more visible than at a fine level.

The process of a bit-rate/distortion optimization gives the quantification step associated with each bit rate to be applied to each hierarchical level of the motion to have optimum encoding.

v. The values of the hierarchical levels are then quantified for a given bit rate and sent into an arithmetic encoder (1311).

Lossy Encoding

One of the innovations of the invention relative to existing schemes is that the motion is encoded with losses. Lossy encoded motion enables the reconstruction of a video having the same appearance as the original video but offset at the pixel level.

Indeed, the reconstructed video is actually synthesized with the decoded pieces of information on motion and texture. The lossy encoding of motion takes account the fact that the human eye is less sensitive to the motion defects of a video than to the texture defects. Thus, the bit rate gained on motion has repercussions on the encoding of the texture and improves it.

### 6.7 Encoding of the Texture

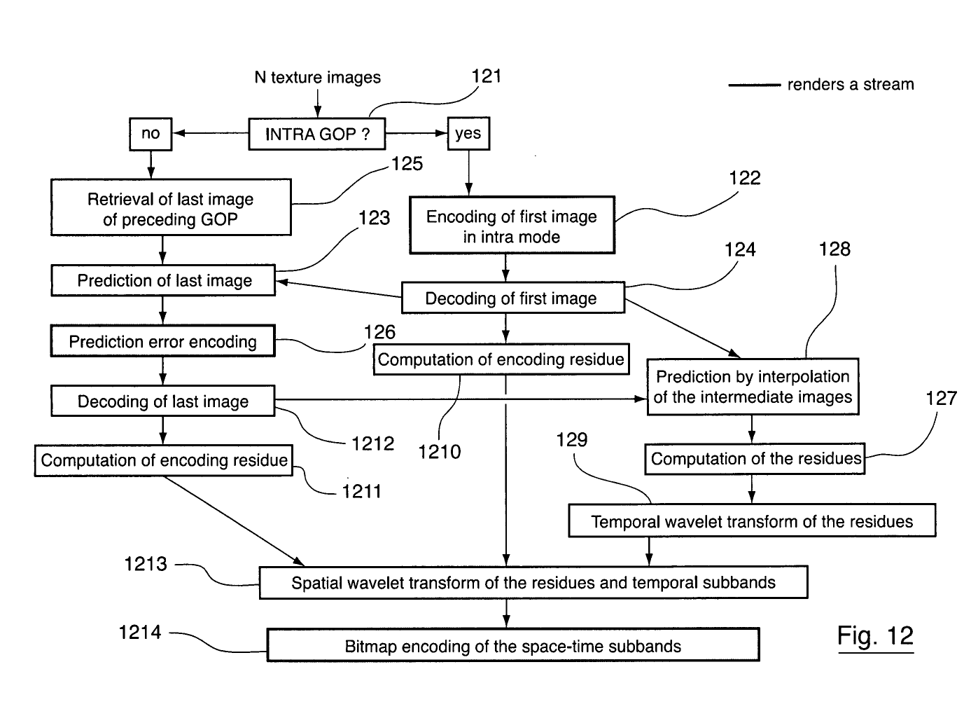

The principle of this encoding is illustrated by the algorithm of FIG. 12.

Encoding in the Lower Layer

i. If the GOP to be encoded is an intra GOP (test 121), the first image of the GOP is subjected to intra encoding (122) with a JPEG-2000 encoder.

ii. The last image of the GOP (123) is predicted with the first image. If the GOP is an intra GOP, then the image used for the prediction is the first image of the decoded GOP (124); if not it is the last image of the preceding encoded-decoded (125) GOP. The prediction error is encoded (126) by a JPEG- 2000 encoder.

Encoding in the Top Layer

i. The far-end images encoded in the top layer are an encoding refinement as compared with the bottom layer. If the GOP is an intra GOP, the first image in the top layer is a refinement of encoding on this image. If the GOP is an inter GOP, there is no refinement for this image. The refinement for the last image is always present.

ii. As in the case of motion, interpolation residues are computed (127) on the intermediate images, using interpolated images (128). Let I(1) and I(N) be the far-end images of the GOP, res(t)=I(t)−I(1)−(1-t)/N*I(N).

iii. The residues are then converted by a temporal wavelet transform (129). The wavelet transform is used in its “lifting” form and the filter used is the 5/3 filter (given in appendix 1).

The transform is applied to the residues of the intermediate images along the path of the motion.

Motion compensations are then necessary when computing coefficients that do not use the same reference image.

iv. The transform is a “zeroside” transform. With the interpolation performed, the signal to be converted is zero at the far ends. Indeed, the values of the first image of the GOP and of the last image are at zero by the interpolation used: I(t)ᵢₙₜₑᵣₚ=(1−a)*I(1)+a*I(N) , for I(1) and I(N), a respectively equal to 0 and 1, then giving 0 for the residues in 1 and N.

FIG. 11 gives the shape of the residue signal considered I(t)-I(t) interp. The shape of the signal shows the validity of the prediction of the signal texture (and motion) by linear interpolation. The prediction is exact at the far end and ever less certain as and when the centre of the GOP is approached. During the temporal transform, the transform signal is the interpolation residue defined between 2 and N-1.

At the time of the computation of the coefficients located at the edges of the signal, a symmetry is applied to the signal to enable the simulation of a signal with a support of infinite length. However, since the value of the signal at 1 and N (at these points the signal is zero), the transform is actually considered to be applied from 1 to N. Consequently, it is no longer a symmetry that is applied to the edges but an anti-symmetry.

v. The subbands resulting from the wavelet transform 129 and the refinements of encoding of the far-end images (obtained by computation of the residues 1210 and 1211, respectively on the first decoded image (124) and the last decoded image (1212)) are then encoded by a JPEG-2000 type scalable progressive encoder 1214.

The levels of wavelet decomposition used in the spatial wavelet decomposition 1213 are different depending on the nature of the component to be encoded. The encoding residues are the high frequencies which it is preferable to transform with few wavelet decomposition levels; only one decomposition level and blocks sized 16x 16 are used. For the temporal subbands, the frequency of the subband is taken into account: for the low frequency, five decomposition levels are used; three levels are used for the very high frequencies and four levels of decomposition for the intermediate frequencies. The size of the blocks is 64×64 whatever the subband.

### 6.8 Bitstream

The bitstream is formed by four streams resulting from the four encodings: low-level texture stream, low-level motion stream, lifting texture stream, lifting motion stream. The layout of the bitstream is a multiple-field layout that depends on the application necessitating the bitstream.

The application has three fields available: motion, texture and shape. Each field may be cut anywhere, a basic quality being provided for each field by the information of the bottom layer of each field. The application may then select the desired quality (motion texture and shape) for each field, and the resulting fields are then multiplexed to form a bitstream to be transmitted to the user.

### 6.9 Decoding Process

The decoding process retrieves the motion and texture information of the binary stream. First the motion is decoded and then the texture.

Decoding of the motion:

An even hierarchical meshing is generated by the decoder on the first image, in the same way as had been done by the encoder, and thus the initial meshings of the encoder and decoder are identical. The positions of the motion in the last image are then decoded, and the positions of the meshing of the first image are added to these positions.

The positions of the intermediate images are interpolated, as in the encoding, by the position in the last image and in the first image. Then, the motion information of the top layer is decoded at the bit rate indicated as a parameter.

The pieces of decoded information correspond to the motion space/time subbands. The inverse wavelet motion transform is applied to the subbands, then the inverse temporal wavelet transform (Antonini synthesis filter given in appendix 1) is applied. The residues obtained are added to the previously interpolated values.

Decoding of the texture:

The decoding of the texture is similar to the encoding of the motion. It is however necessary to ascertain that the current GOP is an intra GOP. If this is the case, the first piece of information on texture of the bottom layer to be decoded is the texture of the first image of the GOP. Once this image has been decoded, the residue of the last image is decoded and added to the prediction of the last image (the prediction being made in the same way as with the encoding by the first image).

The intermediate images are then interpolated as was done with the encoding. If the GOP is an inter GOP, the prediction of the last image of the GOP is done by means of the last decoded image of the preceding GOP. The pieces of information on texture of the top layer are then decoded. The encoding residues of the first and last images of the GOP are respectively added to it.

The temporal subbands of the intermediate images are converted by 5/3 wavelet lifting, the filters used in lifting in the direct transform and the reverse transform are the same and only the signs of the two steps are inverted, according to the lifting principle explained in appendix 2.

The residues obtained are added to the previously interpolated intermediate images.

Synthesis of the Video Sequence:

The synthesis of the video sequence projects the texture images on their original sampling grid: this is the phase that couples motion and texture to ultimately obtain a synthesized video sequence that is as close as possible to the original video sequence.

Measurement of Quality of the Reconstructed Video Sequence:

The computation of the PSNR between the reconstructed video and the original video does not give a reliable criterion for judging the visual quality restituted by the reconstructed video. Indeed, the lossy encoding of motion implies that the video sequence is synthesized with an offset relative to the original sequence, with the computed PSNR being then biased by this shift.

The criterion used then to measure the quality of the synthesized sequence is a PSNR computed in the field of the texture images. The assumption made is that the human eye is not sensitive to the motion defects of a sequence, to the extent that the defects remain below a certain threshold.

Consequently, the texture PSNR, which computes the distortion between the original texture images and the decoded texture images, renders a measurement of restituted quality of the synthesized sequence.

### 6.9 Management of the Reversals Generated by Meshing-based Motion Estimation

Principle

The deformable meshings define a continuous representation of a motion field while the real motion of a video sequence is by nature discontinuous. Thus, when different planes and objects overlap in a scene, zones of concealment and uncovering appear, generating lines of discontinuity.

Making models of such artefacts by a total meshing, as opposed to meshings segmented according to the video objects constituting the scene, constitute a difficulty that cannot be resolved without modification of the representation model. The challenge then is to eliminate this visual deterioration but also to limit it in terms of analysis, in determining the faulty zones. Classically, this type of disturbance of the real motion field leads, in its meshed representation, to reversals as can be seen in FIG. 14.

Usually, to resolve this problem, two types of techniques are used: post-processing and the setting up of non-reversal constraints.

Post-processing can be done according to two types of scenarios: the first scenario (a posteriori correction) consists in applying the motion vectors as such, detecting those that are defective and then correcting their value; the second type proceeds iteratively, adding a part of the expected shift to the nodes at each iteration such that there is no reversal, and setting up a loop until there is convergence of the process.

With the post-processing methods acting once the estimation is achieved, the result is sub-optimal because the motion vectors are corrected independently of their contribution to the minimizing of the prediction error. One improvement therefore consists in optimizing the field in taking account of the non-reversal constraints during the optimizing process.

For this purpose, the motion estimation must be adapted by adding an augmented Lagrangian to the mean square error of prediction, this Langrangian enabling the correction of the deformation of the triangles when they approach the zero area triangle. This technique makes it possible effectively to determine the optimum solution to the problem if it represents a continuous field. Now, since the nature of a video sequence is discontinuous, it is possible to use another technique for determining the zones of discontinuities in order to restore them by generating the appearance or disappearance of objects.

Approach used in the embodiment described

In the patent document FR-99 15568, this approach resolves the problem of reversal generated by the meshing-based motion estimator.

It consists in letting the motion estimator create the reversals between two successive instants tl and t 2 ; thus, in identifying the reversal zones, the zones of discontinuities are detected. The process then consists in making a new motion estimation between tl and t 2 in excluding the defective zones (zones containing at least one reversal) in order to minimize the prediction error between the two images considered.

This re-optimization is used to determine the optimal motion vectors for the continuous zone (i.e. assuming a bijective mapping between tl and t 2) and thus preventing the disturbance of the values of the motion vectors obtained in the previous optimization generated by the zones of discontinuities.

In this approach, the defective zones can then be processed in three different ways.

Artificial Propagation

The first idea consists in artificially propagating the motion vectors of the vertices of the meshing having excluded the defective zones, called INSIDE vertices, toward the vertices of the defective zones for which we have optimized the compactness of the triangles concerned. This propagation relies on a front-rear dual iterative scanning, applied to the vertices of the lowest level of the pyramid where the motion vectors have been optimized (level referenced Lₘ). This approach is based on the computations of the chamfer distance map in Edouard THIEL, “Les distances de chanfrein en analyse d'images : fondements et applications” (Chamfer distances in image analysis: foundation and applications), Thesis at the Universite Joseph Fourier de Grenoble presented on 21 Sep. 1994). It follows the following algorithm:

Algorithm:

For all the vertices S of Lₘ

if INSIDE(S) then S becomes PROPAGATED else S
becomes non-

PROPAGATED

iterate so long as there remain undefined motion vectors

for all the vertices S of Lₘ scanned from top left
to bottom right

if non-PROPAGATED(S) and S possess at

least two PROPAGATED neighbors

then MOTION(S) = average of the MOTIONs of the

PROPAGATED neighbors

S becomes PROPAGATED

for all the vertices S of Lₘ scanned from bottom right to top left

if non-PROPAGATED(S) and S possess at

least two PROPAGATED neighbors

then MOTIONS (S) = average of the MOTIONs of the

PROPAGATED neighbors

S becomes PROPAGATED

for all the vertices P of the pyramid crossed from Lₘ₋₁ to L₀

MOTION(P) = MOTION (F) P is

father of F

It is also possible to use two other techniques: merge or collapse of vertices and n-manifold meshings.

Collapse of Vertices

The first method consists of the detection, at the decoder, of the concealment zones determined by the triangles having vertices at the antagonistic motion vectors (CA criterion). Effectively, the triangles thus detected are capable of getting reversed since the vertices are positioned in different objects (one of the two objects concealing its neighbor).

In this case, it is proposed to perform an edge merger or edge collapse between two neighboring vertices having an antagonistic motion. The result thereof is the disappearance of a triangle, expressing the disappearance of a part of an object.

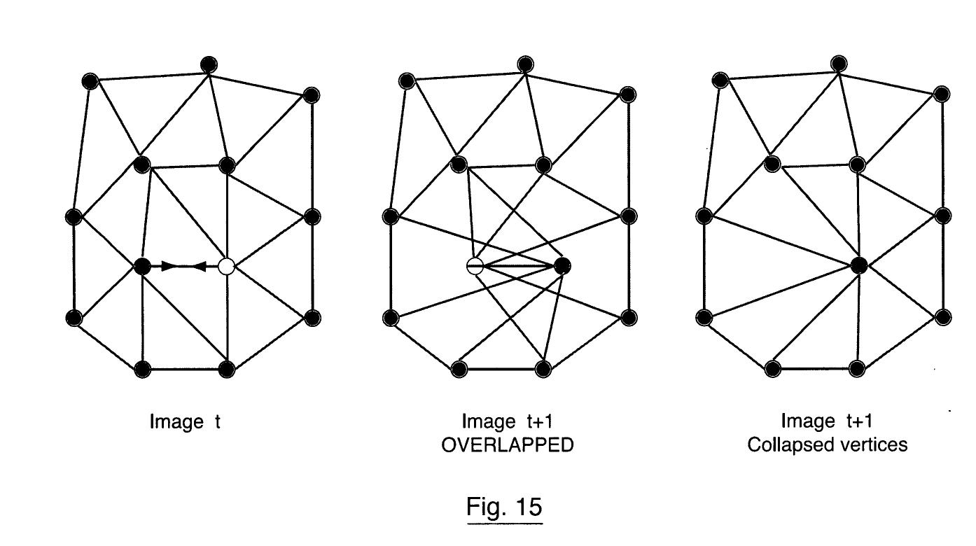

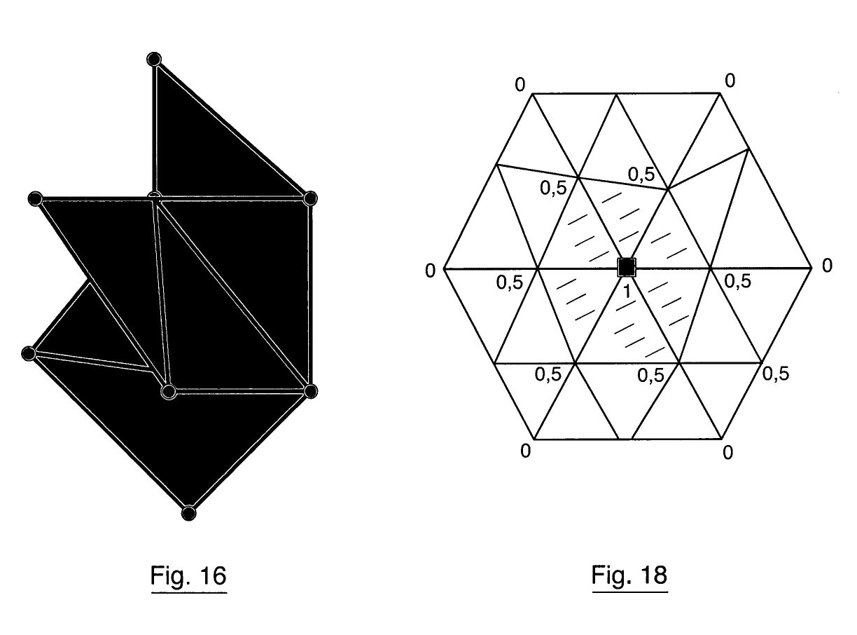

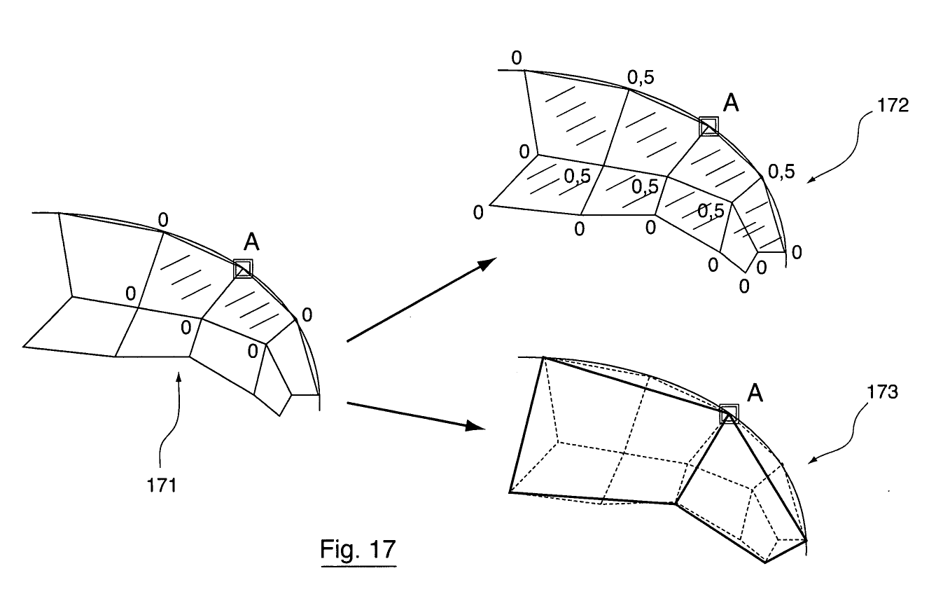

This principle is illustrated by FIG. 15.

“n-manifold” Meshing

A second method consists in working on the n-manifold meshings (one edge may be shared by n, n>=2, triangles instead of 1 or 2 habitually). To do this, motion estimation is performed. When a concealment zone is detected (reversal of triangles), the triangles then associated with the zones are marked with aflag OVERLAPPED (newflag).

The optimization of motion is then redone in excluding the OVERLAPPED triangles. The second optimization may lead to the reversal of the new triangles: these triangles are also marked OVERLAPPED and the optimization is again calculated. The OVERLAPPED zone thus marks the uncovering or overlapping.

The zones marked OVERLAPPED, therefore correspond to objects that have been concealed. The idea chosen consists in temporarily removing these triangles, while at the same time keeping them in memory in order to manage their future reappearance economically.

According to the topology of an OVERLAPPED sub-meshing, two cases arise:

the boundaries of the sub-meshing are withdrawn. The meshing becomes an n-manifold meshing (with n =3);

only one part of the boundaries of the sub meshing is withdrawn and, in this case, a local intra correction must be made on the other OVERLAPPED meshes.

The fact of using n-manifold meshing preserves the pieces of photometric information relative to zones capable of disappearing but also reappearing at various times during the sequence.

An example of such “n-manifold” meshing is illustrated by FIG. 16.

### 6.10 Exemplary implementation for the management of the reversal of the meshings:

detection and disconnection of the degenerate or reversed triangles:

In order to limit mesh reversals, the triangles capable of prompting reversals are detected at the end of the 1-to-t estimation. These triangles have a degenerate shape and cause disturbances in the estimation of motion; they indicate zones of uncovering and overlapping.

When detected, these meshes are disconnected from the rest of the meshing and the estimation is relaunched without taking account of the zones. Similarly, the reversed triangles are detected and disconnected from the meshing. The detection of the reversed triangles is done by checking whether the triangle is defined in the positive or negative sense. Initially, all the triangles are oriented in the positive (direct) sense; if, during the computation of the vector product of the triangle, the sign is negative, then the triangle is reversed. The detection of the degenerate triangles is done by studying the deformation of the triangle between the image l and the image t.

The deformation of a triangle may be studied in considering the motion parameters of the triangle from 1 to t. If (x,y) is the position of a point at 1 and (x′,y′) the position of the point at t, the parameters of the affine motion are such:
x′=ax+by+c
y′=dx+ey+f
that is, in matrix form:

$$[ \begin{matrix}{x}^{′} \\ {y}^{′}\end{matrix} ] = A [ \begin{matrix}x \\ y\end{matrix} ] + B ,$$

B expressing the translation parameters, and A the zoom and rotation parameters. Since the translation does not deform the triangle, we look only at the matrix A. Let D be the diagonal matrix of A,

$$D = [ \begin{matrix}{λ}_{1} & 0 \\ 0 & {λ}_{2}\end{matrix} ] ,$$

with λ₁ and λ₂ being the eigen values of A.

A test is first of all carried out on the ratio of the eigen values to know whether the deformation is a total zoom. The ratio of the eigen values may be computed through the trace of A² and the determinant of A.

In the case of a total zoom (change of resolution of the same magnitude in x and y), the triangle is not considered to be deformed because its structure is the same in t and in 1 in except for a factor of scale.

Should the ratio of the eigen values be different from 1, the deformation is not the same in both senses. The eigen values of A are then studied. The resolution of the trinomial x²-traceA²*x+(detA)², where x is one of the eigen values of A, gives us the two eigen values of A. Depending on the value of the eigen values, the triangle is considered to be degenerate or not degenerate. If it is degenerate, it is disconnected from the meshing.

### 6.11 Motion Estimation Based on the Multiple-rid Approach

In order to improve the convergence of the algorithm patented in Sept 98 (98 11 227) on a method for the estimation of motion between two images based on a nested hierarchical meshing, we have developed a novel technique derived from the world of applied mathematics, known as the multiple-grid technique.

To do this, we shall describe the multiple-grid approach associated with the finite elements.

A search is made for:
uεV_{N}, a(u,v)=L(v), ∀vεV_{N} (I)
where V_{N} represents a vector state sized N, a(u,v) a bilinear form on V_{N}×V_{N} and L(v) a linear form on V_{N}.

From each subspace V_{M}⊂V_{N} sized M<N, it is possible to build a method of resolution at two levels as follows:

Given ũεV_{N} as an approximation of the exact solution u, the correction c=u−ũ therefore verifies:
cεV_{N}, a(c,v)=L(v)−a(ũ,v), ∀vεV_{N}, (II)

An approximation C_{M} of c is defined by:
C_{M}εV_{M} verifying a(c_{M},w)=L(w)−a(ũ,w), ∀wεV_{M} (III)

Let us examine the matrix representation of the different problems. Let φ)hd i,1≦i≦N denote the basic functions of V_{N} etΦⱼ, 1≦j≦M those of V_{M}.

Since ΦⱼεV_{M}⊂V_{N}, there are therefore coefficients rⱼᵢ such that:

Let R denote the matrix of L(R^{N}, R^{M})whose coefficients are the values rⱼᵢ. A function yεV_{M}⊂V_{N} that is written

$$y = {\sum }_{j} {y}_{j} {Φ}_{j}$$

is therefore also written as:

$${\sum }_{j , i} {y}_{j} {r}_{ji} {φ}_{i} = {\sum }_{i} {x}_{i} {φ}_{i}$$

which defines the extension operator by:

$${x}_{i} = {\sum }_{j} {y}_{j} {r}_{ji} that is x = {R}^{t} y$$

The solution u if (I) is written as

$${\sum }_{i} {u}_{i} {φ}_{i}$$

Again let Uε

[symbol]

denote the vector of components uᵢ. If the matrix AεL

[symbol]

and the vector bεR^{N} are defined by:
aᵢⱼ=a(φⱼ,φᵢ) and bᵢ=L(φᵢ)

It is known that u is a solution of:

Au=b

and c, the solution of (II), verifies:
Ac=b−Aũ
it is verified that C_{M} the solution of (III) satisfies:
(RAR^{t})C_{M}=R(b−Aũ)

This systematic way of defining approximations in V_{M} for problems posed in V_{N} enables the construction of the functions, all defined on the same domain, namely the domain corresponding to the fine meshing even if they are characterized by parameters attached to the nodes of the coarse meshing.

FIG. 17 illustrates this approach in one example, setting up an association, with a fine meshing 171, of an accurate coarse meshing 172 and an inaccurate coarse meshing 173.

In order to facilitate the understanding of the algorithm, we shall resolve the system Hd=F on two grids.

The linear system Hd=F is written on the fine grid.

Let P be the extension operator of the coarse grid on the fine grid; then the two-grid method is formulated as follows:

Having obtained, after several Gauss Seidel iterations (for example), an approximation \tilde{d}, the residue F−H\tilde{d} is computed. A search is made for the collection v to be added to \tilde{d},in the form v=Pw, where w is the solution of
QHPw=Q(F−H\tilde{d})

The operator on the coarse grid is therefore represented by the matrix QHP.

It may be noted that Q=P^{t} is a possible restriction operator which, should H be a positive defined symmetrical matrix, has the advantage of leading to the matrix P^{t}HP which is a positive defined symmetrical matrix; P^{t}HP is the restriction of the matrix H to the vector subspace ImP).

Let us try to determine an extension operator P, Q=P^{t}.

If P is the bilinear extension operator on a regular meshing defined by the formulae:

$$( IV ) ⇔ {V}_{h} ( j , k ) = \{ \begin{matrix} {V}_{H} ( j , k ) si ( j , k ) ∈ {M}_{couarse} = {M}_{G} \\ 0.5 [ {V}_{H} ( {j}_{1} , {k}_{1} ) + {V}_{H} ( {j}_{2} , {k}_{2} ) ] with ( {j}_{1} , {k}_{1} ) , ( {j}_{2} , {k}_{2} ) ∈ {M}_{G} \times {M}_{G}\end{matrix}$$

(with h as the discretization pitch of the fine meshing and H that of the coarse meshing)
then P^{t} is a multiple of the “weighted average” operator with:
P^{t}V_{H}(j,k)=Vₕ(j,k)+0.5[Vₕ(j₁,k₁)+. . . +Vₕ(jᵥ,kᵥ)]
where v represents the valence of (j, k)
in taking a classic injection operator, we lose:
Q=P^{t}

Computation of the Reduced Matrices P^{t}HP on the Coarse Grids

H results from the discretization of a variational problem and brings into play, at each point (v+1), values of the unknown function, namely the value at the point in question and the values at the v closest neighbors.

V(o) shall denote the neighborhood of the point 0 and of its v closest neighbors.

The extension operator P of the coarse grid on the fine grid (IV) shall be chosen as illustrated in FIG. 18.

Let i, be the index of a point Gᵢ of the coarse grid and kb the index of a point Fₜ of the fine grid while the coefficients of the matrix P will take the following values:

$$\{ \begin{matrix} 1 & if {G}_{i} and {F}_{k} are indistinguishable \\ 0.5 & if {G}_{i} and {F}_{k} are neighbors on the fine grid \\ 0 & else\end{matrix}$$

The general formula of the product of the matrices enables the following to be written for B =P^{t}HP:

$${B}_{ij} = {\sum }_{kl} {( {P}^{t} )}_{ij} {H}_{kl} {P}_{lj} = {\sum }_{k , l} {P}_{ki} {H}_{kl} {P}_{lj}$$

For Bᵢⱼ to be non-zero, there should be at least one index kεV(i) and one index lεV(j) such that Hₖₗ≠ 0, i.e. that k and l are neighbors, all the neighborhoods being taken on the fine grid.

It is easy to see that Bᵢⱼ cannot be non-zero unless the points having indices i and j are neighbors on the coarse grid.

Simplified Algorithmic Principle (on Two Grids)

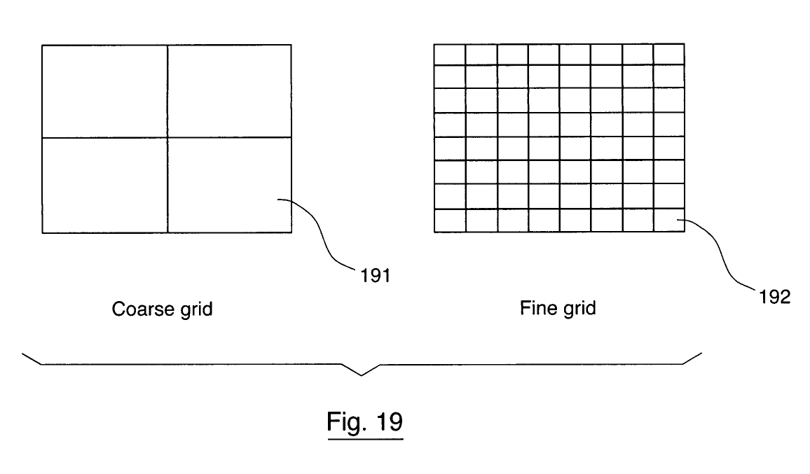

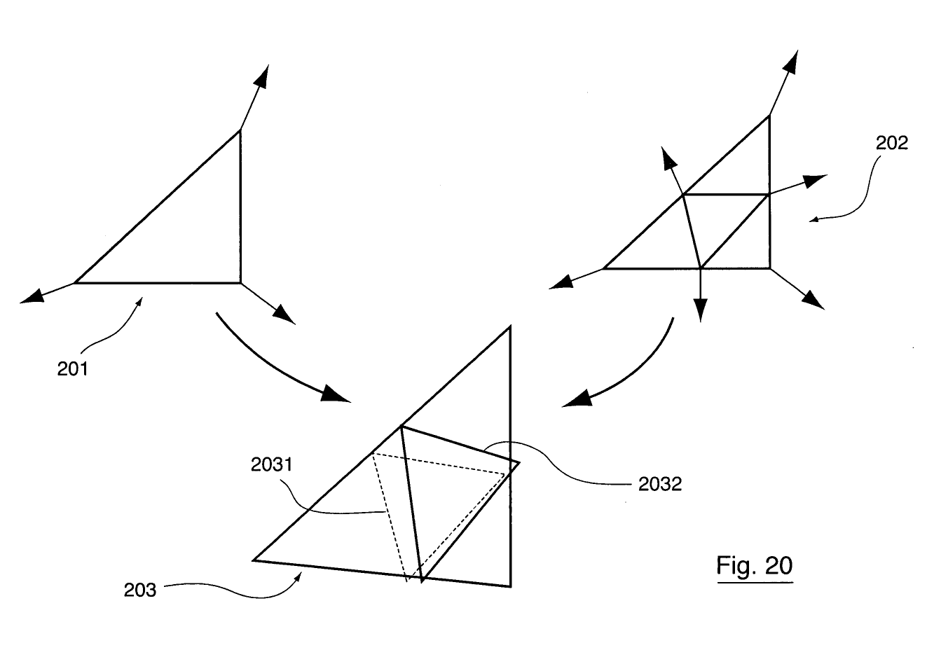

In one cycle, the following steps are performed, in using the coarse grid 191 and fine grid 192 illustrated in FIG. 19.

i. Performing a few Gauss Seidel iterations (for example) on the fine grid 192 with a pitch h (generally 2 or 3);

ii. Computing the residue on the fine grid 192;

iii. Restricting this residue on the coarse grid 191 with a pitch H=2h, the restriction being done by weighted average;

iv. Resolving the system on the coarse grid to obtain an approximation of the correction;

v. Interpolating this correction on the fine grid 192 to correct the approximate solution obtained on the fine grid 192.

If, at the end of this step, the residue on the fine grid is too great, another cycle is begun, in resuming the operations at the start of the first step. To resolve the system of equations on the coarse grid, it is possible to use a two-grid method again. In this case, we use a multiple-grid method.

The Principle of the Geometrical Multiple-Grid:

The geometrical multiple-grid uses the approach describe here above, but strives to weight the nodes between successive levels by weights taking account of the geometrical deformation of the meshing. Indeed, the previously used weights are used to reconstruct a fine meshing from the lower-level regular meshing.

However, when the meshing is deformed, these weights cannot be used to preserve the structure of the lower meshings. To preserve the structure of the lower meshings, it is proposed to modify the weighting used on the nodes at the repercussion of the shift from one level to the other, as illustrated in FIG. 20, which shows:

201: deformations of the nodes of the coarse meshing;

202: deformations of the nodes of the fine meshing;

203: deformation of the fine meshing:
2031: normal deformation (in dashes);
2032: multiple-grid deformation (bold).

Between two successive hierarchical levels, the nodes of the fine meshing may be represented by their barycentrical coordinates with respect to the coarse level triangle to which they belong. Two types of nodes are then distinguished at the fine meshing level: the nodes that are the direct offspring of the upper-level nodes and upper-level mid-ridge nodes.

The direct offspring nodes directly take the value of their parent. For the other type of nodes, four nodes may potentially come into play in the linear combination of the value of the node: the four nodes of the two triangles containing the upper-level ridge. If the node is on the ridge, then only the two nodes at the ends of the ridge come into play, and the barycentrical weights of the other two nodes of the two triangles containing the ridge are zero value nodes. If the node is not on the ridge, the nodes that come into play are the three nodes of the upper-level triangle to which the fine-level node belongs.

The matrix of passage between two successive levels is then very hollow. It is then possible to define the matrix of passage between two non-consecutive levels by: H^{l}ₗ₋ₖ=H^{l}ₗ₋₁H¹ₗ₋₂. . . H^{l-k+1}ₗ₋ₖ, where H^{l}ₗ₋₁ is the matrix of passage between two consecutive levels.

Supplementary Information:

A more detailed explanation, and proposals for improving this multiple-grid technique are presented in appendix 4.

### 6.12 Tracking of Meshing—Making Dynamic Mosaics of Video Objects

Tracking Meshings

The motion estimation technique presented in the preceding section is used to estimate motion between two successive images. The tracking of the meshing in time then consists in estimating the motion between the image t where the position of the following meshing is available, and the image t+1. The use of a multiple-grid estimation technique is then of vital importance in this phase, since the meshing on the image t is a deformed image, and since the hierarchical classic estimation based on regular meshings can very soon stall.

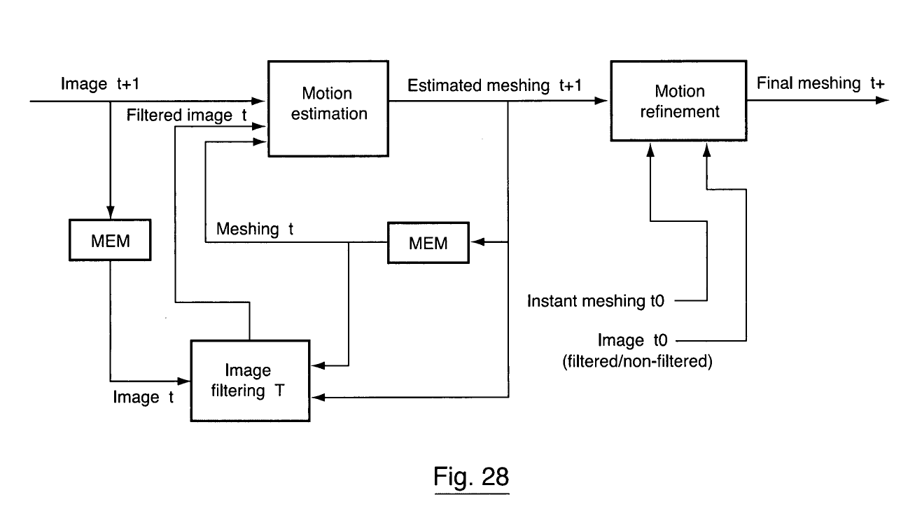

The proposed tracking algorithm is presented in FIG. 28.

The motion estimation is done in two stages. Firstly between the image t and t+1, then a refining operation is performed between the image t+1 and the initial image of the processed sequence. The reference images may be filtered in order to limit the noise but also in order to take account of the temporal variations in texture (cf. dynamic mosaics described here below).

The use of filtered images is used especially for the creation of video object mosaics where it is preferable to use the texture of the mosaic at the instant t rather than the texture of the original image at the instant t. The phase of motion refinement between the initial image and the image at the instant t+1 is done in order to optimize the rendering of the images during an image compensation of the type 1 toward t used for the proposed video encoding scheme.

Creation of Video Object Dynamic Mosaics

Through the tracking of the meshing in the course of time, and the use of the support mask (of the tracked video objects or even more simply of the image in the case of a mono-object sequence), it is possible to create a mosaic of the tracked object. This mosaic concatenates the information on texture observed in time and makes it possible to fill the uncovering zones observed.

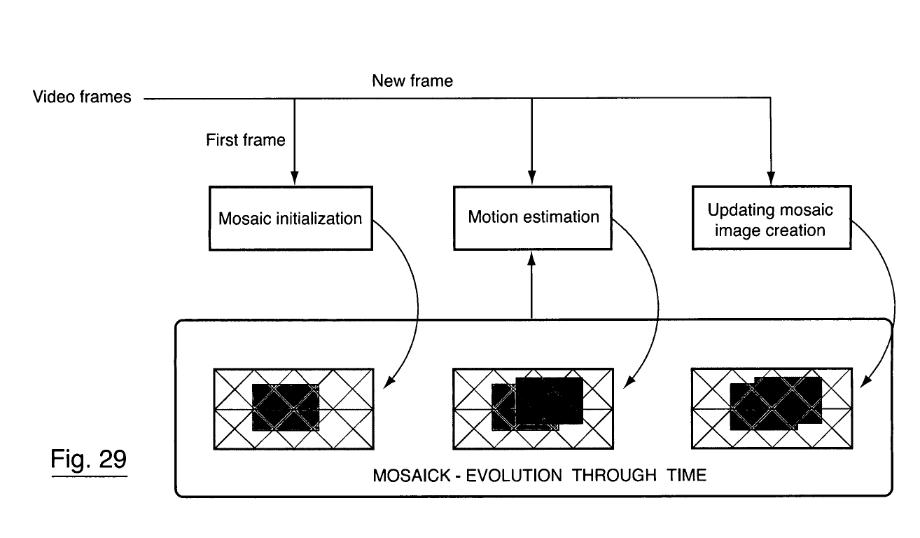

The principle of construction of the mosaics is explained in FIG. 29.

Compared to classic mosaic image reconstruction approaches, the proposed technique enables the management of deformable objects evolving in time, while at the same time not being limited by the usual constraints (objects distant from the camera to have the assumption of a relatively low depth, camera movement limited to “pan and tilt” type movements, etc). This is done by the replacement, in the technique of mosaic creation, of the total motion compensation tool (affine, panoramic, graphic and other types of motion,...) by the tool for motion compensation by hierarchical meshing.

The representation of the hierarchical motion used and its closer link with a wavelet representation (cf. [Marquant-2000]), makes it possible to extend the motion beyond the estimation support.

The mosaic image created is updated progressively in time on the basis of values observed in the images. The updating for the new zones is distinguished from the updating for the zones already present in the mosaic:

$$M ( x , y , t ) = \{ \begin{matrix} I ( x + dx , y + dy , t ) & in a non \text{-} reset zone \\ M ( x , y , t - 1 ) + α [ I ( x , y , t ) - M ( x , y , t - 1 ) ] & in an already reset zone\end{matrix}$$

The parameter α is used to check the filtering performed on the temporal variations of the mosaic. A value of 0 corresponds to a fixed mosaic. The value of 1 corresponds to a non-filtering of the values observed. An intermediate value is used to achieve a temporal Kalman filtering of the values observed.

This filtering may be useful to de-noise the video signal or else reduce the magnitude of the temporal high frequencies in the information to be encoded (cf. encoding of the dynamic mosaics by means of a 3D wavelet approach).

Once this analysis has been made, the mosaics are then completed. First of all, the values obtained at the different points in time are propagated from the future to the past, the propagation being done only on sites that do not yet have defined values. Finally, a padding is done in order to complete the non-defined zones (for which it has not been possible to make any observation).

### 6.13 Complementary Aspects of the Invention

As already mentioned, the invention relates to the encoding method, the decoding method and the corresponding signals, but also the following aspects:

Encoding Device

Such an encoding device comprises wavelet encoding means applied to difference images, called residues, obtained by comparison between a source image and a corresponding estimated image.

Decoding Device

Such a decoding device advantageously comprises:
means for decoding motion in taking account of at least certain of said residues pertaining to the motion to form motion images;
means for decoding the texture, in taking account of at least certain of said residues pertaining to texture, to form texture images;
means for synthesizing a sequence of decoded images, corresponding to said sequence of source images, by projection of said texture images on said motion images.

Dataserver

A data server of this kind, storing and capable of the transmission, to at least one terminal, of at least one signal representing a sequence of source images and obtained by implementing a motion/texture decomposition, producing, for at least some of said source images, information representing motion, called motion images, and information representing texture, called texture images, and a wavelet encoding, the signal comprising digital data representing wavelet encoding applied to difference images, called residues, obtained by comparison between the source image and a corresponding estimated image.

Data Carrier

A digital data carrier of this kind, capable of being read by a terminal, carries at least one signal representing a sequence of source images and obtained by implementing a motion/texture decomposition, producing, for at least some of said source images, information representing motion, called motion images, and information representing texture, called texture images, and a wavelet encoding. The carrier comprises digital data representing wavelet encoding applied to difference images, called residues, obtained by comparison between the source image and a corresponding estimated image.

Computer Encoding Program

Such a computer program comprises instructions to implement an encoding of a source image sequence, implementing a motion/texture decomposition, producing, for at least some of said source images, information representing motion, called motion images, and information representing texture, called texture images, and a wavelet encoding. The program comprises especially wavelet encoding means applied to difference images, called residues, obtained by comparison between the source image and a corresponding estimated image.

Computer Decoding Program

Such a computer program comprises instructions to implement a decoding of a source image sequence, encoded by an encoding implementing a motion/texture decomposition, producing, for at least some of said source images, information representing motion, called motion images, and information representing texture, called texture images, and a wavelet encoding. Said wavelet encoding is applied to difference images, called residues, obtained by comparison between the source image and a corresponding estimated image. It comprises:
means for decoding motion in taking account of at least certain of said residues pertaining to motion to form motion images;
means for decoding texture, in taking account of at least certain of said residues pertaining to texture, to form texture images;
means for synthesizing a sequence of decoded images, corresponding to said sequence of source images, by projection of said texture images on said motion images.

### APPENDIX 1

### Filters Used

1. Antonini filter: 7/9 Filter from M. Antonini, M. Barlaud, P. Mathieu, and I. Daubechies, “Image coding using wavelet transform”, IEEE Transactions on Image Processing”, Vol. pp. 205-220, 1992.
   AntoniniSynthesis={−6.453888262893856e-02, −4.068941760955867e-02, 4.180922732222124e-01, 7.884856164056651e-01, 4.180922732222124e-01, −4.068941760955867e-02, −6.453888262893856e-02};
   AntoniniAnalysis={3.782845550699535e-02, −2.384946501937986e-02, −1.106244044184226e-01, 3.774028556126536e-01, 8.526986790094022e-01, 3.774028556126537e-01, −1.106244044184226e-01, −2.384946501937986e-02, 3.782845550699535e-02 };
2. 5/3 Filter: Cohen Daubechies Feauveau bi-orthogonal (2.)

$$Analysis = - \frac{1}{4 \sqrt{2}} ( 1 + {z}^{- 4} ) + \frac{2}{4 \sqrt{2}} ( {z}^{- 1} + {z}^{- 3} ) + \frac{6}{4 \sqrt{2}} {z}^{- 2}$$

$$Synthesis = \frac{1}{2 \sqrt{2}} ( 1 + {z}^{- 2} ) - \frac{2}{2 \sqrt{2}} {z}^{- 1}$$
3. 5/3 filter en lifting version:

$$Step P = \frac{1}{4} ( 1 + {z}^{- 1} )$$

$$Step U = - \frac{1}{2} ( z + 1 )$$

$$Scaling on even parity \text{:} S = \sqrt{2}$$

$$Scaling on odd parity \text{:} S = \frac{1}{\sqrt{2}}$$

### APPENDIX 2

### Principle of Lifting

The conversion of the signal by a filter bank can be done in two different versions: either a convolutive version, or a lifting version. The convolutive version is the best-known and costliest in terms of computation cost and rounding-out errors. For the wavelet conversion of the signal 1D s(t) by two filters, one high-pass filter H and one low pass filter L, the following is the transformed convolutive wavelet:

$$bf ( t ) = {\sum }_{k} L ( k ) * s ( t - k )$$

$$hf ( t ) = {\sum }_{k} H ( k ) * s ( t - k ) ,$$

with bf being the low frequencies and hf being the high frequencies.

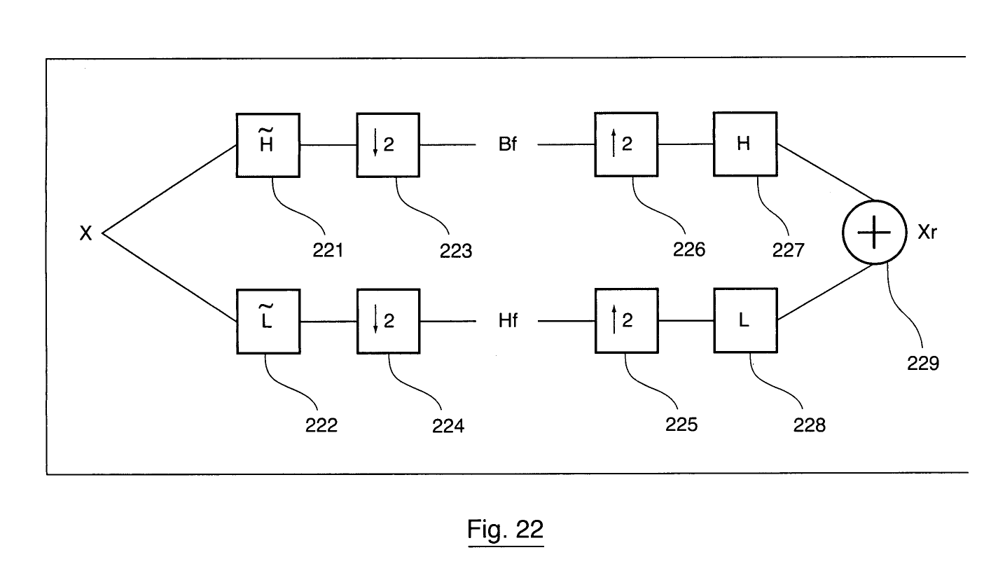

The low and high frequencies are then decimated by 2 to keep the same information numbers as in the initial signal. FIG. 22 shows the decomposition of a signal X into low and high frequencies using high-pass filters 221 and low-pass filters 222 and then decimation by two 223, 224.

The second half of the figure shows the reconstruction of the signal: expansion of the low signals 225 and high signals 226 by two (in interposing zeros between each value) and filtering with the synthesis filters 227 and 228, then the combination 229.

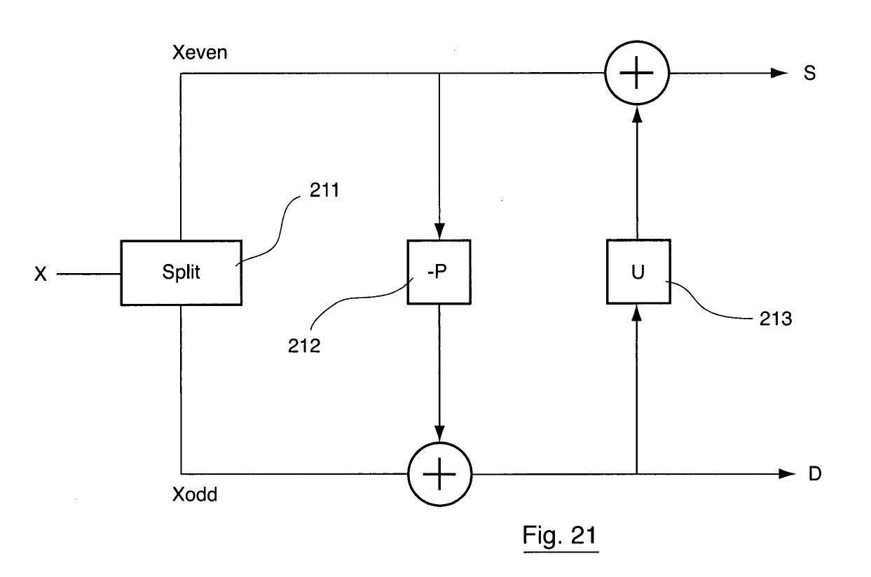

The lifting version decomposes the signal into low-frequency and high frequency components as in the convolutive version, but its scheme has the advantage of managing the rounding-out errors and having lower computation cost . In lifting (see FIG. 21), the signal to be converted is first of all separated into two by the operator SPLIT 211 to obtain Xeven and Xodd.

In fact, Xeven contains the samples of the even-parity index signals and Xodd those of the odd-parity index signals.

Then, the operator P 212 predicts the odd-parity signal by the even-parity signal: \hat{X}odd =Xeven, the prediction \hat{X}odd is taken away from Xodd, and the resulting signal is the high-frequency component of the signal. The even-parity signal is then updated by the operator U 213. The resultant signal is the low-frequency component of the signal. A lifting step is constituted by two filtering operations P and U. A wavelet transform is a succession of lifting steps applied each time to the updated signal.

The inversion of the lifting scheme is simple and fast: it is enough to invert the additions by subtractions, the operators P and U do not change. The lifting version of a convolutive filter may be computed by Euclidean division of the convolutive filters, but lifting filters may be created without having any equivalent in terms of convolutive filters. In the present encoder, the only filters used in lifting are already-existing convolutive filters; the following is the construction of the lifting scheme on the basis of existing convolutive filters:

We consider the analysis and the synthesis of a signal X by a wavelet transform according to FIG. 22. The low frequencies Bf are obtained by filtering the signal X with the low-pass filter \tilde{h}, followed by decimation of the filter signal, the high frequencies Hf by filtering with \tilde{g} and decimation. The reconstruction of the signal is done by filtering with the filters g and h, and the reconstructed signal Xr is obtained.

We should develop the computation of the low frequencies Bf more explicitly by means of the filter \tilde{h}
Bf₀=x₀*\tilde{H}₀+x₁*\tilde{H}₁+x₂*\tilde{H}₂+x₃*\tilde{H}₃+. . .
Bf₁=x₁*\tilde{H}₀+x₂*\tilde{H}₁+x₃*\tilde{H}₂+x₄*\tilde{H}₃+. . .
Bf₂=x₂*\tilde{H}₀+x₃*\tilde{H}₁+x₄*\tilde{H}₂+x₅*\tilde{H}₃+. . .
Bf₃=x₃*\tilde{H}₀+x₄*\tilde{H}₁+x₅*\tilde{H}₂+x₆*\tilde{H}₃+. . .

After the filtering of the signal X by the low-past filter, we decimate the transformed coefficients; the remaining coefficients are:
Bf₀=x₀*\tilde{H}₀+x₁*\tilde{H}₁+x₂*\tilde{H}₂+x₃*\tilde{H}₃+. . .
Bf₂=x₂*\tilde{H}₀+x₃*\tilde{H}₁+x₄*\tilde{H}₂+x₅*\tilde{H}₃+. . .

It is seen that the computation of the low-frequency coefficients can be rewritten in a polyphase form; the coefficients with even-parity and odd-parity indices are separated:
Bf=\tilde{h}ₑsₑ+\tilde{h}ₒxₒ,
xe and xo are the coefficients of the signal with even-parity and odd-parity indices.

Similarly, the high frequencies as well as the reconstructed signal are obtained. The equations of analysis and synthesis are then:

Analysis
Bf=\tilde{h}ₑXₑ+\tilde{h}ₒxₒ
Hf=\tilde{g}ₑxₑ+\tilde{g}ₒXₒ,

Synthesis
Xre=he(Bf)+ge(Hf)
Xro=ho(Bf)+go(Hf)

It is thus possible to define two dual polyphase matrices for the analysis and the synthesis of the signal \tilde{P} and P:

$$\tilde{P} = [ \begin{matrix}{\tilde{h}}_{e} & {\tilde{h}}_{o} \\ {\tilde{g}}_{e} & {\tilde{g}}_{o}\end{matrix} ] and P = [ \begin{matrix}{h}_{e} & {g}_{e} \\ {h}_{o} & {g}_{o}\end{matrix} ]$$

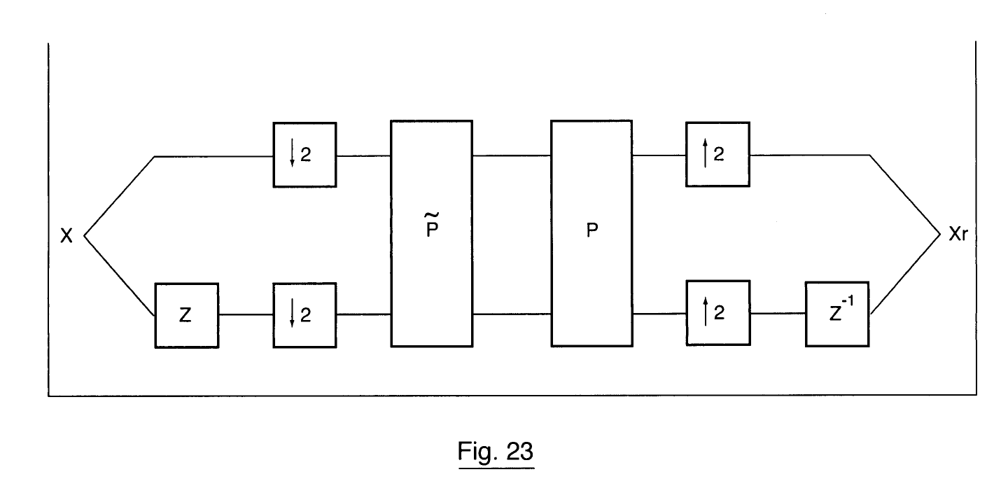

FIG. 23 illustrates the wavelet transform corresponding to the one defined here above with the polyphase matrices. It is shown that P can be factorized in the form:

$$\tilde{P} = [ \begin{matrix}k & 0 \\ 0 & 1 / K\end{matrix} ] [ \begin{matrix}1 & u \\ 0 & 1\end{matrix} ] [ \begin{matrix}1 & 0 \\ - p & 1\end{matrix} ]$$

FIG. 17 shows a lifting stage and a dual lifting stage. The wavelet transform is a succession of these stages. The inverse transform of the lifting is obtained easily in replacing the additions by subtractions.

### APPENDIX 3

### Algorithm 1: Projection of the Image k on the Image i

Inputs of the algorithm:
Mask(i) =definition mask of the image i, indicates which pixels of the image i are defined
Mask(k) =definition mask of the image k
mᵢ=positions of the meshing of the image i
mₖ=positions of the meshing of the image k

Outputs of the algorithm:

Iᵣ=image to be reconstructed, image k projected on the image i

MaskPrediction =definition mask of the image to be reconstructed Iᵣ

For any pixel (x_{j,r},y_{j,r}) of Iᵣ,
if (x_{j,r},y_{j,r}) defined in Mask(i)

determine t the triangle of mᵢ containing (x_{j,r},y_{j,r}) ;
compute the weights w_{1,ti}, w_{2,ti}, w_{3,ti} of (x_{j,r},y_{j,r})
associated
with the nodes of t ;
determine the new ₚₒₛᵢₜᵢₒₙ of (x_{j,r},y_{j,r}) in mₖ by:
x_{j,mk}= w_{1,ti}* x_{1,mk}+ w_{2,ti}* x_{2,mk}+ w_{3,ti}* x_{3,mk} where x_{1,mk},
x_{2,mk}, x_{3,mk} are the positions in x of node of t;
y_{j,mk}= w_{1,ti}* y_{1,mk}+ w_{2,ti}* y_{2,mk}+ w_{3,ti}* y_{3,mk};
if (x_{j,mk},y_{j,mk}) defined in Mask(k)

compute luminance of (x_{j,mk},y_{j,mk}) by bilinear
interpolation;

MaskPrediction(x_{j,r},y_{j,r}) = true;

end if
Else MaskPrediction(x_{j,r},y_{j,r}) = false;

end if
else MaskPrediction(x_{j,r},y_{j,r}) = false;

end for

### APPENDIX 4

### Multiple Grid Estimation

1. General Principle

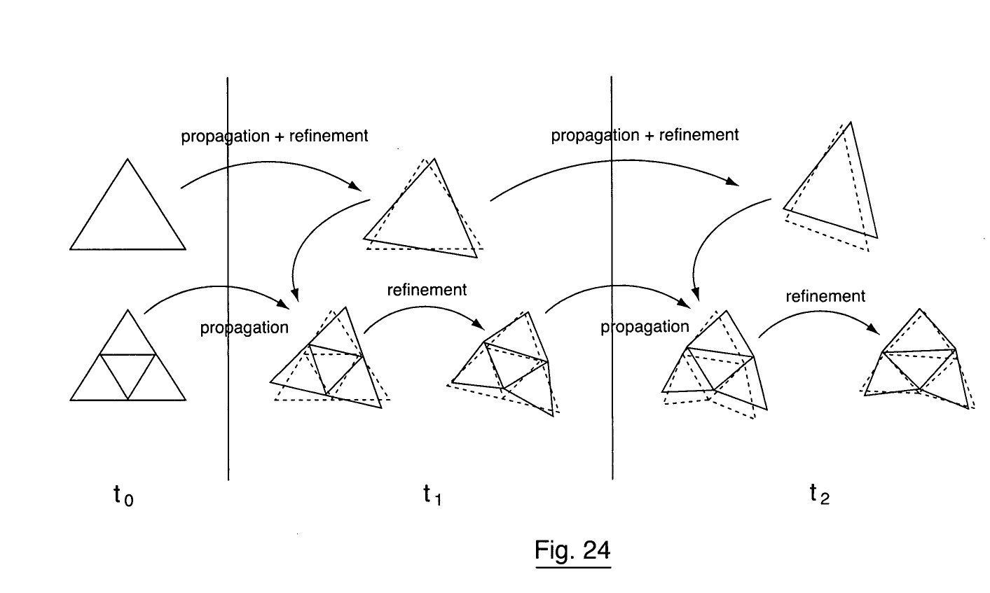

During the phase of tracking the meshing in time, there appears a problem wherein the meshings in which the motion is estimated are no longer hierarchical regular meshings. The hierarchical estimation of motion then becomes difficult. In [Marquant-2000], a technique was thus proposed to enable the estimation of motion with hierarchical meshings, in propagating the estimation of the motion performed on regular triangles of a given hierarchical level on the next finer level (cf. FIG. 24). This approach can then soon becomes suboptimal in the case of pronounced meshing deformations, where the motion estimated on large triangles may be fairly different from the real motion of the deformed structure (the estimation support of the large triangle is indeed different from the support of the meshes supposed to constitute this triangle).

In order to resolve this problem, a multiple-grid type of minimizing technique was then set up. This technique relies on the search for a deformation of the meshing defined by means of a reduced set of parameters. To do so, advantage is taken of the hierarchical structure of the meshing.

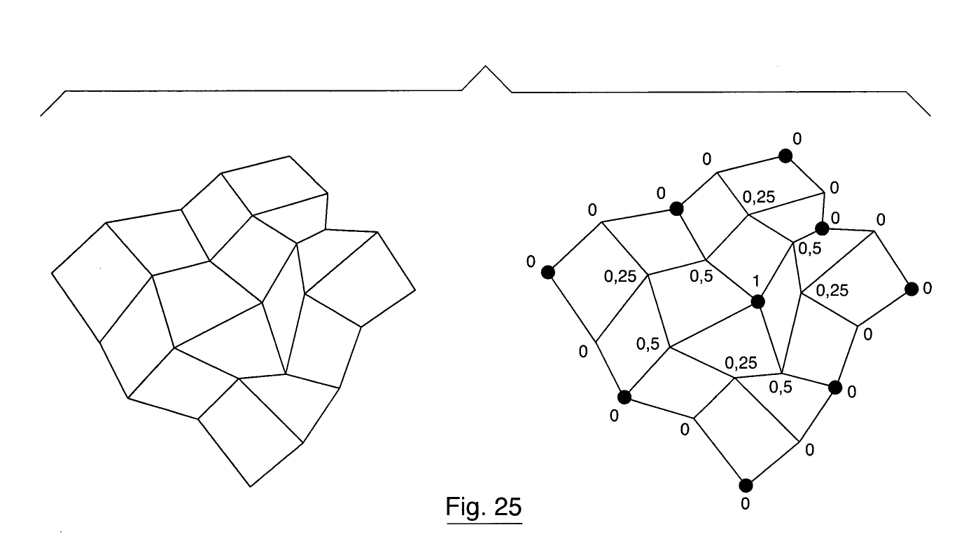

The reference dpᵢ^{l} denotes the shift associated with the node indexed i, at the level of the meshing hierarchy 1. A reduced set of parameters to obtain a deformation field at the hierarchical level 1, may then be obtained from the deformation field of the level 1-1: the shift ^{dp}^{^{l−1}}ⱼ is passed on to the nodes indexed i of the level 1 as follows (cf. Also FIG. 25 for the case of a quadrangular meshing):

$$\{ \begin{matrix} {dp}_{j}^{l - 1} & if the node i is the direct offspring of the node j \\ \frac{1}{2} {dp}_{j}^{l - 1} & \begin{matrix}if the node i is situated in the middle of \\ an arc in contact with the node j\end{matrix}\end{matrix}$$

This relationship between the shifts of the levels 1 and 1-1 can then be written in matrix form: [dp^{l}ᵢ] =Hₗ₋₁¹[dpⱼ^{l-1}], and generally, in successively applying this formula: [dpᵢ^{l}]=Hₗ₋ₖ^{l}[dpⱼ^{l-k}] with Hₗ₋ₖ^{l} =Hₗ₋₁^{l} Hₗ₋₂^{l-1}. . . Hₗ₋ₖ^{l-k+1}. If the optimum deformation of this type minimizing the prediction error is used, it is then possible to show that the system defining the optimum shifts gets transformed from the general formula at the level l: A^{l}[Δdpᵢ^{l ]=B}¹ into the system:
(^{t}Hₗ₋ₖ^{l}A^{l}Hₗ₋ₖ^{l})[Δdpⱼ^{l-k}]=(^{t}Hₗ₋ₖ^{l}B^{l}).

This multiple grid estimation is then used in the hierarchical estimation scheme of the motion in estimating the motion no longer on a least fineness meshing, but by means of shifts of the nodes of these coarser meshings.

2. The Geometrical Multiple Grid

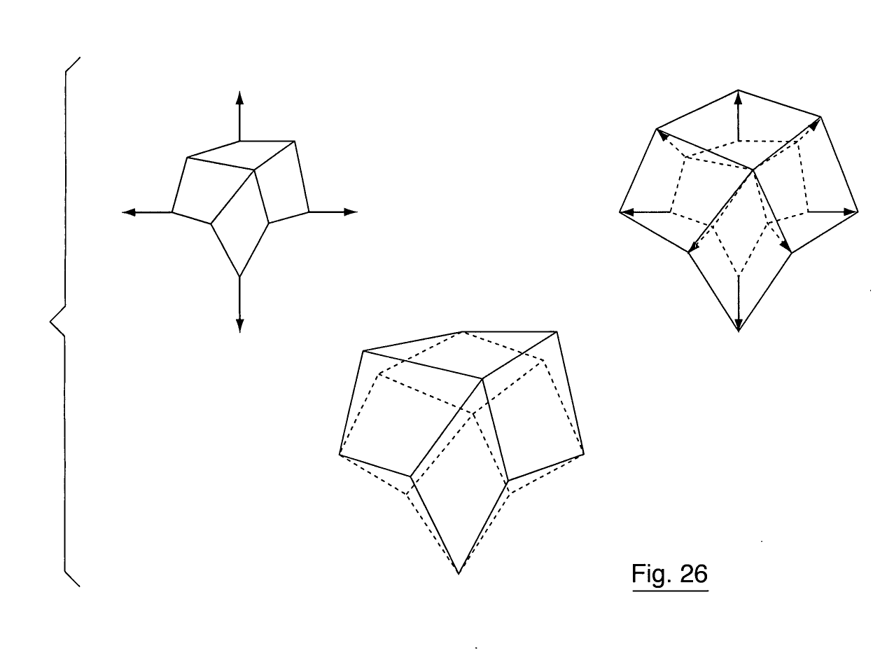

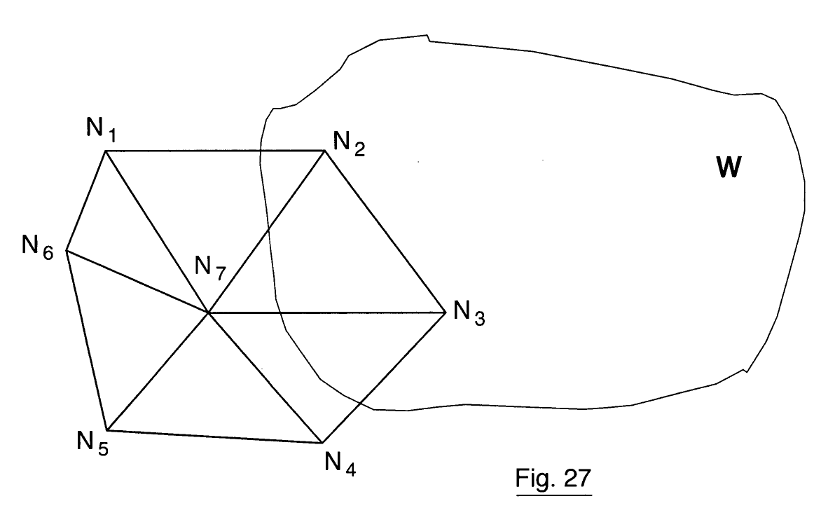

In the approach presented here above, it can be observed that the weightings between the nodes of levels of successive hierarchy (1 and 0.5) are somewhat empirical. In fact these weights are the weights to be applied on a regular meshing in order to preserve the regular structure of the lower-level meshing. However, when the meshing is deformed, the use of the weightings does not ensure preserving the structure of the lower meshings. Thus, in FIG. 26, in the case of a total zoom, the structure of the meshing is no longer kept (the deformation applied to the lower-level meshing does not correspond to a total zoom).

In order to overcome this problem, we therefore propose to modify the weighting used on the nodes during the repercussion of the shift from one level to another. In observing that, between two successive hierarchical levels of meshing, the nodes of the fine meshing can finally be expressed as a linear combination of the nodes of the upper hierarchical level (use of a barycentrical representation for each node relative to the coarse level triangle containing this node); this property will then be used for the repercussion of the shift of the nodes.

At the level of the fine meshing, two types of nodes can be distinguished: the direct offspring nodes of the nodes of the upper level, and the offspring nodes of a ridge of the upper level. For the first type of node, there is then a direct repercussion, and then only one node comes into play. For the second type of node, in the weighting formula, potentially four nodes can come into play (the nodes of both triangles on either side of the ridge). Then the two end nodes of the ridge are used as well as the additional node of the triangle of the upper level containing the node. Should the offspring node be located on the ridge, only the end nodes of the ridge are used (the barycentrical coordinate on the other nodes being 0). The resulting matrix Hₗ₋₁^{l} is then still very hollow (no more than three non-zero values per line). In order to obtain the matrix of passage between non-consecutive hierarchical levels, the invention then uses the preceding composition formula:
Hₗ₋ₖ^{l}=Hₗ₋₁^{l}Hₗ₋₂^{l-1}. . . Hₗ₋ₖ^{l-k+1}.

3. Making the Motion Estimation Algorithm Robust

The motion estimation algorithm relies on a differential minimizing of motion, and can be rapidly disturbed by computation noise. It is therefore necessary to make the estimation algorithm robust, especially in the resolution of the system of equations to be resolved to find the shift increments [Δdp]. The solution proposed [Lechat-1999] is to use a Levenberg-Marquardt technique in order to recondition the linear system to be resolved. This technique consists, in the system AX=B, of increasing the diagonal of the matrix A as long as no reduction of the functional value to be minimized has been observed. This increase of the diagonale is done on all the lines of the matrix, and has the consequence of braking the shift of all the nodes and not only nodes undergoing problems.

Several modifications were then tested in order to limit this phenomenon, and limit other drifts, in proposing limited and well-adapted increases in the diagonal terms of the matrix A:

3.1 Reconditioning to Limit the Shift of the Nodes

Through the use of a differential minimizing technique, the increments of shifts found must be limited (typically in the range of 1 pixel at the resolution processed). Thus, during the resolution of the system AX=B, a check is made to ensure that all the components are well within the maximum tolerated shift. If not, an increase is made in the diagonal term of the matrix A attached to the line of said coefficient. This increase is made similarly to the Levenberg Marquard technique, A′_{ii=(L+λ)}Aᵢᵢ, and this is done as many times as necessary in order to comply with the constraint.

3.2 Reconditioning Relative to the Aperture Problem

In the context of the estimation of motion, the aperture problem is a problem that is frequently encountered. This problem is related to the fact that owing to the preferred orientation of the texture gradient, the information on local motion can be defined reliably only in one direction (i.e. the direction of the gradient). In the case of the estimation on a meshing, this problem is limited (because the influence of a node bears on the pixel contained in the triangles in contact with this node); however, it appears in zones having a marked orientation of texture (for example at the boundaries between two weakly textured zones where a sliding of meshes can be seen along the contours).

This phenomenon can be explained more clearly at the level of the resolution of the system A.X=B. By its nature, the system does not have a dominant diagonal, and may have a large number of “acceptable” solutions. Thus, the technique of the conjugate gradient may find solutions such that ∥AX−B∥ is low. Now, this may give rise to a large number of solutions if the matrix A has low eigen values (as may be the case for the classic aperture problem).

The approach proposed then consists, for each node, in identifying the sensitivity of the nodes relative to a noise on the optimum shift vector. It can thus be seen that the standard of the noise on ∥AX−B∥ related to a shift noise on (dxᵢ,dyᵢ) can be expressed as a quadratic form (in considering only this noise): A_{xi,xi}dxᵢ²=2.A_{xi,yi}dxᵢdyᵢ=A_{yi,yi}dyᵢ² The term A_{x,x} corresponding to the standard Lₛsquared of the line of coefficients associated with the unknown quantity dxᵢ (ditto for the term A_{yy}), the term A_{xy} corresponding to the scalar product between the lines of the matrix A attached to the unknown quantities dxᵢ and dyᵢ. A rotation of a reference mark may then be made on (dxᵢ,dyᵢ) in order to have a quadratic form of the form A′_{xi,xi}du_{I}²+A′_{yi,yi}dvᵢ². λ₁ and λ₂ then represent the sensitivity of the system for certain directions of shift of the node considered (a low value indicates that the system is poorly conditioned on the associated variable, while a high value indicates efficient conditioning). In order to make the algorithm robust, a change of variable is then made on the system (rotation for each node), with the smallest possible increase of the diagonal on each node in order to have values of λ₁ and λ₂ that are of the same magnitude.

3.3 Reconditioning Relative to a Minimum Texture Gradient

Another source of poor conditioning of the matrix A, relates to the presence of zones where the gradient of the image is low. To this end, the notion of an average minimal gradient is then introduced. In looking at the expression of the coefficients of the matrix A, it can be seen that the diagonal terms are expressed in the form of a weighted sum of gradients. A standardized system Aₙₒᵣₘ is then computed, where the terms of image gradients are omitted in the formula. The reconditioning is then done by dictating the following:
Aᵢⱼ>∇Iₘᵢₙ[Aₘᵢₙ]ᵢⱼ .

Experimentally, it can be seen that the value of 10 for this minimum gradient term generally gives good results that do not generate excessive smoothing (this smoothing effect is due to a smoothing relative to a total motion computed on a coarser meshing hierarchy).

3.4 Reconditioning Relative to the Estimation Support

The introduction of an estimation support Ω into the motion estimation phase also induces problems of conditioning for the linear system to be resolved. For example, FIG. 27 shows that the node Nᵢ is a node that has been poorly conditioned because its influence on the points within the triangle N₁N₂N₇ is limited (and hence a great shift may be tolerated on this node). In order then to limit this problem, a notion of smoothing is introduced on the nodes. However, the introduction of smoothing may limit the quality of the motion estimator. Hence, the smoothing on the nodes is done only on the nodes having incomplete estimation supports.

A smoothing energy having the following form is then added between the two neighboring nodes i and j: μ([A_{norm,full}]ᵢⱼ−[A_{normΩ}]ᵢⱼ )×(DPᵢ−DPⱼ)². A_{normfull} and A_{norm,Ω} represent the system of “standardized” equations (i.e. without use of the image gradient term) respectively with a complete mask and with the mask Ω. μ is the weighting term used to control the force of the smoothing; a good magnitude for this term lies in taking the value of the minimum gradient of texture used previously.

It must be noted that the different operations of reconditioning may be done on the different linear systems to be resolved. The use of weighting using standardized matrices makes it possible to limit the adjusting of the parameters introduced in automatically taking account of the problems of changing resolution and of automatically variable sizes of triangles. Finally, the scheme proposed by Levenberg-Marquardt is used following these various reconditioning operations only if a diminishing of the functional factor to be minimized is not observed.

1-47. (canceled)

48. Method for the encoding of a sequence of source images, implementing a motion/texture decomposition, producing, for at least certain of the source images, information representing motion, called motion images, and information representing texture, called texture images, and wavelet encoding, characterized in that the method comprises the following steps:
estimating the motion so as to obtain said motion images;
projecting each of said source images on at least one reference grid so as to obtain said texture images, on which the effect of the motion has been cancelled;
comparing a motion image and a corresponding estimated image so as to obtain a motion difference image, called a motion residue;
comparing a texture image and a corresponding estimated image so as to obtain a texture difference image; and
independent wavelet encoding of said motion residues and said texture residues.

49. Encoding method according to claim 48, characterized in that said comparison implements a difference with an interpolated image using at least the first and/or the last image of said sequence.

50. Encoding method according to claim 48, characterized in that a temporal encoding of said texture is performed, being rectified by said motion preliminarily encoded along the temporal axis, by means of a wavelet encoding.

51. Encoding method according to claim 48, characterized in that it comprises an encoding of the texture comprising a temporal wavelet encoding followed by spatial wavelet encoding.

52. Encoding method according to claim 48, characterized in that it comprises a motion encoding that takes account of a meshing.

53. Encoding method according to claim 48, characterized in that it comprises a motion encoding comprising a temporal wavelet encoding followed by a spatial wavelet encoding.

54. Encoding method according claim 48, characterized in that said source images are grouped together in image blocks comprising a variable number (N) of source images.

55. Encoding method according to claim 54, characterized in that two successive image blocks comprise at least one common image.

56. Encoding method according to claim 48, characterized in that said source images are grouped together in image blocks and, in each of said image blocks, the motion of all the images of an image block is estimated from the first image of said block.

57. Encoding method according to claim 48, characterized in that that said source images are grouped together in image blocks and said projection step uses two reference grids respectively representing the first and last images of the block considered.

58. Encoding method according to claim 48, characterized in that it comprises:
projecting step of an image on at least one reference grid, corresponding to a sampling grid defined by the position of the nose of a meshing in an image, so as to obtain a texture mask, and
a detection step of at least one image support zone that has remained undefined after said projection of an image, owing to the use of a reference grid corresponding to another image, and a padding step of the said undefined image support zone or zones.

59. Encoding method according to claim 48, characterized in that an antisymmetry is applied to the wavelet coefficients corresponding to an edge of the image so as to simulate a signal with support of infinite length.

60. Encoding method according to claim 48, characterized in that the encoded data are distributed into at least two layers, a bottom layer comprising data enabling an image of coarse quality to be reconstructed and a top layer enabling the quality of said coarse image to be refined.

61. Signal representing a sequence of source images and obtained by an encoding method according to claim 48, and implementing a motion/texture decomposition, producing, for at least some of said source images, information representing motion, called motion images, and information representing texture, called texture images, and a wavelet encoding,
characterized in that the signal comprises first digital data representing a wavelet encoding applied to motion difference images, called motion residues, obtained by comparison between a motion image and a corresponding estimated image,
and second digital data representing wavelet encoding applied to texture difference images, called texture residues, obtained by comparison between a texture image and a corresponding estimated image, on which the effect of the motion has been cancelled, said first data being encoded independently of said second data.

62. Signal according to claim 61, characterized in that it is it is constituted by at least two layers, one bottom layer comprising data enabling a coarse quality image to be reconstructed and one top layer enabling the quality of said coarse image to be refined.

63. Signal according to any of the claim 61, characterized in that it comprises three fields to describe an object, respectively representing its motion, its texture and its shape.

64. Method for the decoding of a sequence of source images, encoded by an encoding implementing a motion/texture decomposition, producing, for at least certain of said source images, information representing motion, called motion images, and information representing texture, called texture images, and wavelet encoding,
characterized in that said wavelet encoding being applied to difference images, called residues, obtained by comparison between a source image and a corresponding estimated image, it comprises the following steps:
decoding the motion, in taking account of at least certain of said residues pertaining to the motion, to form motion images;
decoding the texture, in taking account of at least certain of said residues pertaining to texture, to form texture images; and
synthesizing a sequence of decoded images, corresponding to said sequence of source images, by projection of said texture images on said motion images.

65. Decoding method according to claim 64, characterized in that it comprises a measurement step of the quality of said sequence of decoded images, by analysis of the distortion between the original texture images and decoded texture images.

66. Decoding method according to claim 64, characterized in that it comprises a management step of the reversals generated by said motion estimation.

67. Decoding method according to claim 64, characterized in that it comprises a stopping step of the processing of said residues, when a level of quality and/or a quantity of processing operations to be performed is attained.

68. Device for the encoding of a sequence of source images implementing a motion/texture decomposition, producing, for at least certain of said source images, information representing motion, called motion images, and information representing texture, called texture images, and wavelet encoding,
characterized in that it comprises means of wavelet encoding applied to difference images, called residues, obtained by comparison between a source image and a corresponding estimated image.

69. Device for the decoding of a sequence of source images, encoded by an encoding implementing a motion/texture decomposition, producing, for at least certain of said source images, information representing motion, called motion images, and information representing texture, called texture images, and wavelet encoding,
characterized in that said wavelet encoding being applied to difference images, called residues, obtained by comparison between a source image and a corresponding estimated image, it comprises:
means for decoding motion in taking account of at least certain of said residues pertaining to the motion to form motion images;
means for decoding texture, in taking account of at least certain of said residues pertaining to texture, to form texture images; and
means for synthesizing a sequence of decoded images, corresponding to said sequence of source images, by projection of said texture images on said motion images.

70. Data server characterized in that it comprises means to implement the encoding method according to any of the claim 48.

71. Digital data carrier capable of being read by a terminal, characterized in that it carries at least one signal according to claim 61, obtained by means of an encoding method according to claim 48.

72. Computer program, characterized in that it comprises instructions to implement an encoding of a sequence of source images, implementing a motion/texture decomposition, producing, for at least certain of the source images, information representing motion, called motion images, and information representing texture, called texture images, and a wavelet encoding,
characterized in it comprises instructions to perform:
an estimation of the motion so as to obtain said motion images;
a projection of each of said source images on at least one reference grid so as to obtain said texture images, on which the effect of the motion has been cancelled;
a comparison between a motion image and a corresponding estimated image so as to obtain a motion difference image, called a motion residue;
a comparison between a texture image and a corresponding estimated image so as to obtain a texture difference image; and
independent wavelet encoding of said motion residues and said texture residues.

73. Computer program, characterized in that it comprises instructions to implement a decoding of a sequence of source images, implementing a motion/texture decomposition, producing, for at least certain of the source images, information representing motion, called motion images, and information representing texture, called texture images, and wavelet encoding,
characterized in that said wavelet encoding being applied to difference images, called residues, obtained by comparison between a source image and a corresponding estimated image, it comprises:
means for decoding motion in taking account of at least certain of said residues pertaining to the motion to form motion images;
means for decoding texture, in taking account of at least certain of said residues pertaining to texture, to form texture images; and
means for synthesizing a sequence of decoded images, corresponding to said sequence of source images, by projection of said texture images on said motion images.
